(19) United States
(12) Patent Application Publication
(10) Pub. No.: US 2015/0001080 A1
(43) Pub. Date: Jan. 1, 2015

(54) Electrophoresis Devices and Methods of Making and Using the Same

(71) Applicant: The Regents of the University of California, Oakland, CA (US)

(72) Inventors: Amy E. Herr, Oakland, CA (US); Todd Duncombe, Berkeley, CA (US)

(21) Appl. No.: 14/372,969

(22) PCT Filed: Feb. 1, 2013
(86) PCT No.: PCT/US2013/024497

§ 371 Date: Jul. 17, 2014

Related U.S. Application Data
(60) Provisional application No. 61/593,782, filed on Feb. 1, 2012.

(51) Int. Cl. G01N 27/447

(52) U.S. Cl. CPC G01N 27/44756; G01N 27/44717
USPC 204/455; 204/601; 204/605; 204/451

(57) ABSTRACT

Embodiments of an electrophoresis device and methods for using the same in analyte separation applications are provided. Certain embodiments of the present disclosure include microfluidic devices having a single electrophoretic separation channel containing a separation medium. Systems according to embodiments of the present disclosure are configured to monitor analyte fronts moving through the electrophoretic separation channel in order to detect differentially migrating analytes, i.e., the systems are configured for moving boundary electrophoresis (MBE).

### CROSS-REFERENCE TO RELATED APPLICATIONS

Pursuant to 35 U.S.C. §119(e), this application claims priority to the filing date of U.S. Provisional Patent Application Ser. No. 61/593,782, filed Feb. 1, 2012, the disclosure of which is herein incorporated by reference.

### INTRODUCTION

Protein separation and immunoassay techniques are important for the diagnosis of infectious diseases (such as HIV, hepatitis C, etc.) or other disorders or conditions of interest. The confirmation of a positive screening result may involve the qualitative and/or quantitative determination of biomarkers for these diseases or conditions. Analytical grade performance—not simply the ‘yes/no’ screening readout (e.g., lateral flow, ‘dip stick’ assays, etc.)—is a hallmark of confirmatory tests. To this end, powerful bench-top electrophoretic immunoassays routinely provide quantitative results that may directly inform patient treatment. However, typical bench-top electrophoresis devices drive species to differentially electromigrate through a sieving matrix, thus yielding protein specific identifying information, but thousands of volts are needed to drive separations over centimeters of separation length.

### SUMMARY

Embodiments of an electrophoresis device and methods for using the same in analyte separation applications are provided. Certain embodiments of the present disclosure include microfluidic devices having a single electrophoretic separation channel containing a separation medium. Systems according to embodiments of the present disclosure are configured to monitor analyte fronts moving through the electrophoretic separation channel in order to detect differentially migrating analytes, i.e., the systems are configured for moving boundary electrophoresis (MBE).

Embodiments of the present disclosure include a microfluidic system that includes a microfluidic device having a single electrophoretic channel containing a separation medium. The microfluidic system further includes a processor configured to detect differentially migrating analytes in the separation medium by a moving boundary electrophoresis (MBE) protocol.

In some embodiments of the system, the separation medium includes a polymeric gel.

In some embodiments of the system, a first portion of the channel is substantially free of the separation medium and a second portion of the channel contains the separation medium. In some embodiments, the first portion of the channel is upstream from the second portion of the channel.

In some embodiments of the system, the channel has a length of 1.5 mm or less.

In some embodiments of the system, the microfluidic device further includes a fluid input port in fluid communication with an upstream end of the channel.

In some embodiments of the system, the microfluidic device further includes a fluid output port in fluid communication with a downstream end of the channel.

In some embodiments of the system, the system further includes a power source configured to apply an electric field to the channel. In some embodiments, the power source includes a battery.

In some embodiments of the system, the system further includes a detector.

In some embodiments of the system, the system includes an array of two or more microfluidic devices.

Embodiments of the present disclosure include a method of assaying a fluid sample for the presence of an analyte. The method includes introducing the fluid sample into a microfluidic device comprising a single electrophoretic channel containing a separation medium, and detecting differentially migrating analytes in the channel by a moving boundary electrophoresis (MBE) protocol to assay the fluid sample for the presence of the analyte.

In some embodiments, the method further includes applying an electric field to the channel.

In some embodiments of the method, the introducing comprises continuously introducing the fluid sample into the microfluidic device during the assay.

In some embodiments of the method, the separation medium comprises a polymeric gel.

In some embodiments of the method, a first portion of the channel is substantially free of the separation medium and a second portion of the channel contains the separation medium. In some embodiments, the first portion of the channel is upstream from the second portion of the channel.

Embodiments of the present disclosure include a kit that includes a microfluidic device having a single electrophoretic channel containing a separation medium and configured to separate differentially migrating analytes in the separation medium by a moving boundary electrophoresis (MBE) protocol. In some embodiments, the kit includes a buffer.

In some embodiments, the kit further includes a power source configured to apply an electric field to the channel. In some embodiments, the power source includes a battery.

### BRIEF DESCRIPTION OF THE FIGURES

FIG. 1(a) shows a schematic drawing of a single channel moving boundary electrophoresis (MBE) microfluidic device, according to embodiments of the present disclosure. FIG. 1(b) shows a photograph of a single channel microfluidic device, according to embodiments of the present disclosure. FIG. 1(c) shows a graph of data interpretation, with detection of an analyte front to determine the presence one or more proteins in a sample, according to embodiments of the present disclosure.

FIG. 2 shows figures of a rapid combined analysis of an immunoassay and a protein separation in a single channel, according to embodiments of the present disclosure. Moving boundary separation was performed on a sample containing 100 nM AF488 labeled Trypsin Inhibitor (TI), Ovalbumin (OVA), Bovine Serum Albumin (BSA) and 75 nM unlabeled anti-OVA IgG Ab. FIG. 2(a) shows a time evolution of fluorescence intensity that indicates electromigration of protein fronts into and through the microchannel (left to right) during MBE. COD images are false color, with protein fronts labeled to indicate the species. FIG. 2(b) shows a graph of separation resolution (SR) vs. location for the analytes, according to embodiments of the present disclosure. The immunoassay is completed in 280 μm. The BSA-TI separation was performed in 680 μm, while OVA-BSA and TI-OVA separations were performed in longer distances. FIG. 2(c) shows a graph of the electropherogram's derivative (dl/dt) vs. time and staggered in the y-axis to display multiple locations along the gel, from 0 to 1110 μm. The electropherogram is overlaid with its derivative at 300 μm (FIG. 2(d)) to display the immunoassay and at 1 mm (FIG. 2(e)) for the protein separation. Zero μm refers to the liquid-gel interface.

FIG. 3 shows a microfluidic device using a 9V battery powered moving boundary electrophoresis protocol in a 1 mm channel, which produced a 3 μW immunoassay in less than 25 seconds with a separation length of 140 μm. FIG. 3(a) shows an image of the 9 V battery below a glass chip containing eight short separation channels. FIG. 3(b) shows a time evolution of fluorescence intensity that indicated electromigration of protein fronts into and through the microchannel (left to right) during MBE. CCD images are false colored. FIG. 3(c) shows a graph of the critical separation resolution of 140 μm from the liquid-gel interface. FIG. 3(d) shows a graph of the electropherogram and its derivative for the positive and negative controls at the critical separation length. FIG. 3(e) shows a graph of a staggered dl/dt plot that shows the separation over 360 μm.

FIG. 4 shows graphs of MBE separation in 5% human serum where detection of an immune complex was performed in 10 s or less, according to embodiments of the present disclosure.

FIG. 5A shows a photograph of a single channel PAG MBE microfluidic device (left), and a schematic illustrating the two media (e.g., free solution and separation medium) contained in the straight microchannel: a free solution region abutting a PAG sieving matrix region yielding a stacking interface, indicated with an arrow (right). FIG. 5B shows a schematic of a sample pipetted into a fluid reservoir (left), an electric field was then applied and analytes electromigrated into the microchannel according to mobility (right). FIG. 5C shows a graph of the free solution-to-PAG transition at the head of the PAG MBE separation axis for decreasing pore-size of the PAG region (3% T, 10% T, 12% T). Fluorescence traces indicate the concentration distribution of TI* as the front electromigrated into PAG MBE channel. PAG density varied, all other conditions were held constant (Δtₛₑₚₐᵣₐₜᵢₒₙ=4 s, E=100 V/cm, [TI*]=500 nM). FIG. 5D shows a graph of corresponding concentration spatial derivatives, dC/dx, for the TI* front injections shown in FIG. 5C.

FIG. 6A shows Epi-fluorescence micrographs showing time evolution of a PAG MBE separation of a native protein ladder (BSA*, OVA* and TI* at 100 nM each), according to embodiments of the present disclosure. False color CCD images are labeled to indicate protein front locations at 3 s elapsed separation time. FIG. 6B shows time evolution of RS which shows the critical separation duration for each analyte pair. FIG. 6C shows a graph of the spatial concentration profile (solid trace) and the spatial derivate of the intensity signal (dl/dx, dashed trace) at 7 s of elapsed separation time. RS for each protein pair is indicated in the inset. A system peak (*) at 20 μm was attributed to gel non-uniformities at the interface and subsequent protein retention. E=300 V/cm, 12% T PAG.

FIG. 7A shows a graph of the electropherogram derivative for each PAG density collected at 90 μm intervals along the PAG region, according to embodiments of the present disclosure. To facilitate visual comparisons, the x-axis of each plot was shifted such that the OVA* peak was centered at 0 seconds. FIG. 7B shows a graph of RS for the BSA*-TI* versus migration distance over a range of gel densities. FIG. 7C shows a graph of RS for each protein in the 14% gel density case. At 200 μm the separation was complete for all proteins: a RS of 1.0, 2.2 and 3.7 for the OVA*-TI*, BSA*-OVA* and BSA*-TI* separations, respectively. E=300 V/cm.

FIG. 8A shows a graph of time evolution of a PAG MBE protein separation and OVA immunoassay, according to embodiments of the present disclosure. The temporal derivative of the analyte concentration distribution was shown at progressive locations along the 10% T PAG. Native protein multimers were detected at 600 μm and 200 μm (BSA dimer and trimer, respectively), and at 900 μm (72 kDa OVA isoform). Electropherogram of the concentration fronts (solid trace) overlaid with the corresponding time derivative (dashed trace) are shown for the homogeneous electrophoretic OVA immunoassay (FIG. 8B) and a negative control using an antibody non-specific to any proteins in the system (FIG. 8C). Detection point was 300 μm downstream of the stacking gel, 900 μm from the injection port. E=300 V/cm.

FIG. 9A shows a schematic (left) and an image (right) of a low-power 3 μW electrophoretic immunoassay (EIA) using PAG MBE driven by a 9 V battery in a 1.3 mm channel. FIG. 9B shows a false color CCD time evolution montage of the EIA (200 nM OVA*, 250 nM OVA-antibody), which shows that the low-power separation was performed in less than 25 seconds. FIG. 9C shows a graph of an overlay of the electropherogram (solid trace) and the temporal derivative (dl/dt, dashed trace) at the 140 μm separation length (FIG. 9D).

### DETAILED DESCRIPTION

Embodiments of an electrophoresis device and methods of using the same in analyte separation applications are provided. Certain embodiments of the present disclosure include microfluidic devices having a single electrophoretic separation channel containing a separation medium. Systems according to embodiments of the present disclosure are configured to monitor analyte fronts moving through the electrophoretic separation channel in order to detect differentially migrating analytes, i.e., the systems are configured for moving boundary electrophoresis (MBE).

Below, the subject microfluidic devices are described first in greater detail. Methods of detecting an analyte in a fluid sample are also disclosed in which the subject microfluidic devices find use. In addition, systems and kits that include the subject microfluidic devices are also described.

### Electrophoresis Devices

Embodiments of the present disclosure include an electrophoresis device. The device may be configured to perform an electrophoretic separation of analytes in a sample using a moving boundary electrophoresis (MBE) protocol, as described in more detail below. In certain embodiments, the electrophoresis device includes a separation medium and is configured to perform MBE using the separation medium as the stationary phase for the electrophoresis. The separation medium may be provided as a monolithic separation medium, such as a contiguous block or slab of the separation medium, e.g., a monolithic gel. In some instances, the electrophoresis device includes a chamber that contains the separation medium. In these embodiments, the electrophoresis device is configured to perform an MBE separation of the analytes in the sample as the sample traverses the monolithic separation medium.

In other instances, the electrophoresis device includes a channel that contains the separation medium. The channel may be an elongated channel, such that the length of the channel is substantially longer than the width of the channel. For example, the length of the channel may be 2 times or more longer than the width of the channel, such as 3 times or more, including 4 times or more, or 5 times or more, or 6 times or more, or 7 times or more, or 8 times or more, or 9 times or more, or 10 times or more, or 15 times or more, or 20 times or more, or 25 times or more, or 50 times or more, or 75 times or more, or 100 times or more longer than the width of the channel. Embodiments of the channel include those where the channel is open to the surrounding environment on one side of the channel (e.g., the channel includes a bottom and two longitudinal sides and is open on the top), and also include embodiments where the channel is enclosed on its four longitudinal sides, such that the channel forms a conduit or capillary channel.

In certain embodiments, the microfluidic device is a single channel microfluidic device. By “microfluidic” is meant that the device is configured to contain small volumes of fluid, such as 1 mL or less, such as 500 μL or less, including 100 μL or less, for example 50 μL or less, or 25 μL or less, or 10 μL or less, or 5 μL or less, or 1 μL or less. As described herein, the device may be configured to perform an electrophoretic separation of analytes in a single channel of the device using a moving boundary electrophoresis (MBE) protocol. By “single channel” is meant that the device includes one channel configured to perform an electrophoretic separation of analytes in a sample using an MBE protocol. In some instances, a single channel microfluidic device does not include intersecting channels. For example, in some embodiments, a single channel microfluidic device does not include a sample loading (e.g., sample injection) channel that intersects the MBE channel. While a given device may include more than one channel, if more than one channel is present, the two or more channels do not intersect. For instance, as described in more detail below, a device may include two or more separate channels, each configured to perform an electrophoretic separation of a sample using an MBE protocol. The channels may be linear or non-linear.

In certain embodiments, the single channel is a single electrophoretic channel configured for electrophoretic separation of a fluid sample. In some cases, the single electrophoretic channel (or multiple non-intersecting channels) include a separation medium. The separation medium may be configured to separate the analytes in a sample from each other. In certain embodiments, the separation medium is configured to separate the analytes in a sample as the sample traverses the separation medium. In some cases, the separation medium is configured to separate the analytes in the sample as the sample flows through the separation medium. In some cases, the separation medium is configured to separate the analytes in a sample based on the physical properties of the analytes. For example, the separation medium may be configured to separate the analytes in the sample based on the molecular weight, size, charge (e.g., charge to mass ratio), isoelectric point, etc. of the analytes. In some embodiments, the separation medium is configured to separate the analytes in the sample based on the charge (e.g., charge to mass ratio) of the analytes. The separation medium may be configured to separate the analytes in the sample into detectable regions of analytes. A detectable region is a region where the concentration of an analyte is significantly higher than the surrounding regions. Each region of analyte may include a single analyte or several analytes, where each analyte in a single region of analytes has substantially similar physical properties, as described above.

In certain embodiments, the detectable region may be identified by a boundary of the region where the concentration of the analyte in the detectable region near the boundary is different from the concentration of the analyte in an adjacent region. In these embodiments, the microfluidic system may be configured to detect differentially migrating analytes in the separation medium by a moving boundary electrophoresis (MBE) protocol. In certain embodiments, in MBE, analytes in a sample are separated based on the motion of charged particles through a medium (e.g., a stationary fluid medium, a separation medium (such as a polyacrylamide gel), and the like) under an applied electric field. For instance, the sample may be a mixture of charged analytes, such as a mixture of charged proteins. On applying voltage, the analytes traverse the separation medium. Differences in the charges of each analyte may result in differences in the speed and/or distance each analyte traverses the separation medium. In some cases, where the analytes include a detectable label (e.g., a fluorescent label), the analytes may be detected by detecting the detectable label.

In certain instances, in MBE, the detectable region may have a front or leading edge (i.e., downstream boundary) where the concentration of the analyte is greater than the concentration of the analyte in the adjacent region (i.e., the region immediately downstream from the detectable region). In these instances, the presence of the analyte may be determined by detecting the boundary between adjacent regions. For instance, the microfluidic device may be configured such that a first analyte traverses through the separation medium faster than a second analyte. In these cases, distinct regions may be detectable as the first and second analytes traverse through the separation medium, such as a first region where the concentration of the first analyte is greater and a second region where the concentration of the second analyte is greater. Because the first analyte traverses the separation medium faster than the second analyte, the first region may be downstream from the second region. In these instances, the boundary between the first and second regions may be detected due to the differences in concentrations of the first and second analytes in the first and second regions as described above. As the analytes traverse the separation medium, the boundary between the first and second regions correspondingly traverses the separation medium, and may be detected at various time points during the assay. Fluid samples may include 1 or more, 2 or more, 3 or more, 4 or more, 5 or more, 6 or more, 7 or more, 8 or more, 9 or more, 10 or more, or even greater numbers of analytes, with detectable boundaries between adjacent regions.

As described above, the single electrophoretic channel may include a separation medium. In certain embodiments, a first portion of the channel is substantially free of the separation medium and a second portion of the channel contains the separation medium. For example, a first portion of the channel may not contain the separation medium, such that during use the first portion of the channel substantially contains a fluid, such as a buffer, the sample fluid, and the like. In some cases, the second portion of the channel contains the separation medium. The first and second portions of the channel may be adjacent to each other and in fluid communication with each other, such that, within the channel, there is an interface between the fluid in the first portion of the channel and the separation medium in the second portion of the channel. In some instances, the first portion of the channel, which is substantially free of the separation medium, is positioned upstream from the second portion of the channel, which contains the separation medium. Stated another way, the second portion of the channel may be positioned downstream from the first portion of the channel. In these instances, fluid and/or sample flowing through the microfluidic device will first flow through the first portion of the channel, and then flow through the second portion of the channel. In some embodiments, the interface between the fluid in the first portion of the channel and the separation medium in the second portion of the channel may facilitate concentrating the analytes in the sample before the analytes traverse the separation medium. In some instances, concentration of the analytes in the sample before the analytes traverse the separation medium may facilitate a reduction in dispersion of the analytes and/or the boundaries between the analytes as the sample traverses the separation medium.

In certain embodiments, the separation medium includes a polymer, such as a polymeric gel. The polymeric gel may be a gel suitable for gel electrophoresis. The polymeric gel may include, but is not limited to, a polyacrylamide gel, an agarose gel, and the like. The resolution of the separation medium may depend on various factors, such as, but not limited to, pore size, total polymer content (e.g., total acrylamide content), concentration of cross-linker, applied electric field, assay time, and the like. For instance, the resolution of the separation medium may depend on the pore size of the separation medium. In some cases, the pore size depends on the total polymer content of the separation medium and/or the concentration of cross-linker in the separation medium. In certain instances, the separation medium is configured to resolve analytes with molecular weight differences of 10,000 Da or less, such as 7,000 Da or less, including 5,000 Da or less, or 2,000 Da or less, or 1,000 Da or less, for example 500 Da or less, or 100 Da or less. In some cases, the separation medium may include a polyacrylamide gel that has a total acrylamide content of ranging from 1% to 20%, such as from 3% to 15%, including from 3% to 10% (w/w). In certain instances, the separation medium includes a polyacrylamide gel that has a total acrylamide content of 3% (w/w). In certain instances, the separation medium includes a polyacrylamide gel that has a total acrylamide content of 6% (w/w). In certain instances, the separation medium includes a polyacrylamide gel that has a total acrylamide content of 10% (w/w). In certain embodiments, the separation medium includes a cross-linker (e.g., a bisacrylamide crosslinker) in an amount ranging from 1% to 10%, such as from 1% to 7%, including from 1% to 5% (w/w). In certain instances, the separation medium includes a cross-linker in an amount of 3% (w/w).

In some embodiments, the separation medium is configured such that the analytes in the sample are separated based on differences in the charges of the analytes. In these embodiments, the separation medium may be configured such that the migration of the analytes through the separation medium is not significantly affected by the pore size of the separation medium. Stated another way, the separation medium may be configured such that the analytes in the sample are not substantially separated based on differences in the size or molecular weight of the analytes. As described above, the microfluidic devices may be configured to separate analytes based on an MBE protocol, and thus may be configured to separate the analytes based on charge, and not based on size.

While the length of the single channel may vary, in some instances the length ranges from 0.1 mm to 10 cm, such as from 0.1 mm to 5 cm, including from 0.1 mm to 1 cm, or from 0.1 mm to 7 mm, or from 0.1 mm to 5 mm, or from 0.1 mm to 3 mm, or from 0.1 mm to 2 mm or from 0.1 mm to 1.5 mm, or from 0.1 mm to 1 mm. In some instances, the channel has a length of 10 mm. In other instances, the channel has a length of 1.5 mm or less, e.g., 1 mm. For example, in some cases, the length of the channel is ultra-short, e.g., 0.1 mm to 20 mm, such as 0.1 mm to 10 mm, e.g., 0.1 mm to 5 mm, including 0.1 mm to 1.5 mm, e.g. 1 mm.

In certain embodiments, the portion of the channel that contains the separation medium is 50% or more of the length of the channel, such as 75% or more, including 80% or more, or 85% or more, or 90% or more, or 95% or more, or 97% or more, or 99% or more of the length of the channel. Correspondingly, the portion of the channel that is substantially free of the separation medium may be 50% or less of the length of the channel, such as 25% or less, including 20% or less, or 15% or less, or 10% or less, or 5% or less, or 3% or less, or 1% or less of the length of the channel. As such, in some embodiments, the channel includes two regions, an upstream region and a downstream region. The upstream region of the channel may be substantially free of the separation medium, as described above. The upstream region may contain a fluid, such as a buffer, sample fluid, etc. The downstream region of the channel may include the separation medium, as described above. In certain cases, the interface between the fluid in the upstream region and the separation medium in the downstream region may facilitate an increase in concentration of the sample at the interface before the sample traverses the separation medium. In some instances, an increase in the concentration of the sample may facilitate a reduction in the diffusion of the detectable regions of the analytes in the sample, thus facilitating an increase in the resolution of the device.

Embodiments of the microfluidic channels may be made of any suitable material that is compatible with the microfluidic devices and compatible with the samples, buffers, reagents, etc. used in the microfluidic devices. In some cases, the microfluidic channels are made of a material that is inert (e.g., does not degrade or react) with respect to the samples, buffers, reagents, etc. used in the subject microfluidic devices and methods. For instance, the microfluidic channels may be made of materials, such as, but not limited to, glass, quartz, polymers, elastomers, paper, combinations thereof, and the like.

In some instances, the microfluidic device includes a fluid input port. The fluid input port may be configured to allow a fluid (e.g., a buffer, a sample fluid, etc.) to be introduced into the microfluidic device, such as into the single channel. The fluid input port may be in fluid communication with the channel. In some instances, the fluid input port is in fluid communication with the upstream end of the channel. The fluid input port may further include a structure configured to prevent fluid from exiting the fluid input port. For example, the fluid input port may include a cap, valve, seal, etc. that may be, for instance, punctured or opened to allow the introduction of a fluid into the microfluidic device, and then re-sealed or closed to substantially prevent fluid, including the sample and/or buffer, from exiting the fluid input port. For example, a fluid (e.g., buffer) may be introduced into the microfluidic device through the fluid input port, and then the fluid input port may be sealed for storage of the microfluidic device until use. In certain embodiments, the microfluidic device includes a single fluid input port.

In some instances, the microfluidic device includes a fluid output port. The fluid output port may be configured to allow a fluid (e.g., a buffer, a sample fluid, etc.) to exit the microfluidic device, such as exit the single channel. The fluid output port may be in fluid communication with the channel. In some instances, the fluid output port is in fluid communication with the downstream end of the channel. The fluid output port may further include a structure configured to prevent fluid from exiting the fluid output port. For example, the fluid output port may include a cap, valve, seal, etc. that substantially prevents fluid, including the sample and/or buffer, from exiting the fluid output port. For example, a fluid (e.g., buffer) may be introduced into the microfluidic device through the fluid input port, and then the fluid input port and fluid output port may be sealed for storage of the microfluidic device until use. In certain embodiments, the microfluidic device includes a single fluid output port.

In certain embodiments, the microfluidic device has a width ranging from 5 cm to 1 mm, such as from 3 cm to 1 mm, including from 1 cm to 1 mm, or from 5 mm to 1 mm. In some instances, the microfluidic device has a length ranging from 10 cm to 1 mm, such as from 5 cm to 1 mm, including from 1 cm to 1 mm, or from 7 mm to 1 mm, or from 5 mm to 1 mm, or from 3 mm to 1 mm, or from 2 mm to 1 mm, or from 1 mm to 1 mm. In certain aspects, the microfluidic device has an area of 50 cm² or less, such as 25 cm² or less, including 10 cm² or less, for example, 5 cm² or less, or 3 cm² or less, or 2 cm² or less, or 1 cm² or less, or 0.5 cm² or less, or 0.25 cm² or less, or 0.1 cm² or less, or 0.05 cm² or less.

In certain embodiments, the microfluidic device is substantially transparent. By “transparent” is meant that a substance allows visible light to pass through the substance. In some embodiments, a transparent microfluidic device facilitates detection of analytes in the separation medium, for example analytes that include a detectable label, such as a fluorescent label. In some cases, the microfluidic device is substantially opaque. By “opaque” is meant that a substance does not allow visible light to pass through the substance. In certain instances, an opaque microfluidic device may facilitate the analysis of analytes that are sensitive to light, such as analytes that react or degrade in the presence of light.

In certain embodiments, the microfluidic device includes additional fluid conduits, such as fluid channels. The additional fluid channels may be in fluid communication with the MBE channel and configured to direct one or more fluids towards or away from the MBE channel. For instance, the device may include a fluid channel configured to carry a flow of a fluid (e.g., buffer solution, wash solution, reagent solution, etc.) to the MBE channel, such as to the fluid input port or to an upstream end of the MBE channel. The device may include a waste channel configured to carry a flow of a waste fluid away from the MBE channel, such as away from a downstream end of the MBE channel. In some instances, the device may include one or more analyte channels configured to carry one or more of the separated analytes away from the MBE channel. The analyte channel may be configured to direct the separated analytes to one or more downstream devices, such as devices configured for further analysis of the separated analytes, e.g., UV spectrometer, IR spectrometer, mass spectrometer, NMR, and the like.

### Methods

Embodiments of the methods are directed to determining whether an analyte is present in a sample, e.g., determining the presence or absence of one or more analytes in a sample. In certain embodiments of the methods, the presence of one or more analytes in the sample may be determined qualitatively or quantitatively. Qualitative determination includes determinations in which a simple yes/no result with respect to the presence of an analyte in the sample is provided to a user. Quantitative determination includes both semi-quantitative determinations in which a rough scale result, e.g., low, medium, high, is provided to a user regarding the amount of analyte in the sample and fine scale results in which an exact measurement of the concentration of the analyte is provided to the user.

In certain embodiments, the microfluidic devices are configured to detect the presence of one or more analytes in a sample. Samples that may be assayed with the subject microfluidic devices may vary, and include both simple and complex samples. Simple samples are samples that include the analyte of interest, and may or may not include one or more molecular entities that are not of interest, where the number of these non-interest molecular entities may be low, e.g., 10 or less, 5 or less, etc. Simple samples may include initial biological or other samples that have been processed in some manner, e.g., to remove potentially interfering molecular entities from the sample. By “complex sample” is meant a sample that may or may not have the analytes of interest, but also includes many different proteins and other molecules that are not of interest. In some instances, the complex sample assayed in the subject systems and methods is one that includes 10 or more, such as 20 or more, including 100 or more, e.g., 10³ or more, 10⁴ or more (such as 15,000, 20,000 or 25,000 or more) distinct (i.e., different) molecular entities, that differ from each other in terms of molecular structure or physical properties (e.g., molecular weight, size, charge, isoelectric point, etc.).

In certain embodiments, the samples of interest are biological samples, such as, but not limited to, urine, blood, serum, plasma, saliva, semen, prostatic fluid, nipple aspirate fluid, lachrymal fluid, perspiration, feces, cheek swabs, cerebrospinal fluid, cell lysate samples, amniotic fluid, gastrointestinal fluid, biopsy tissue (e.g., samples obtained from laser capture microdissection (LCM)), and the like. The sample can be a biological sample or can be extracted from a biological sample derived from humans, animals, plants, fungi, yeast, bacteria, tissue cultures, viral cultures, or combinations thereof using conventional methods for the successful extraction of DNA, RNA, proteins and peptides. In certain embodiments, the sample is a fluid sample, such as a solution of analytes in a fluid. The fluid may be an aqueous fluid, such as, but not limited to water, saline, a buffer (e.g., glycine, Tris, etc.), combinations thereof, and the like.

The samples that may be assayed in the subject methods may include one or more analytes of interest. Examples of detectable analytes include, but are not limited to: nucleic acids, e.g., double or single-stranded DNA, double or single-stranded RNA, DNA-RNA hybrids, DNA aptamers, RNA aptamers, etc.; proteins and peptides, with or without modifications, e.g., antibodies, diabodies, Fab fragments, DNA or RNA binding proteins, phosphorylated proteins (phosphoproteomics), peptide aptamers, epitopes, and the like; small molecules such as inhibitors, activators, ligands, etc.; oligo or polysaccharides; mixtures thereof; and the like.

In some embodiments, the analyte of interest can be identified so that the presence of the analyte of interest can then be detected. Analytes may be identified by any of the methods described herein. For example, an analyte specific binding member that includes a detectable label may be employed (e.g., a fluorescently labeled antibody that specifically binds to the analyte of interest). Detectable labels include, but are not limited to, fluorescent labels, colorimetric labels, chemiluminescent labels, enzyme-linked reagents, multicolor reagents, avidin-streptavidin associated detection reagents, non-visible detectable labels (e.g., radiolabels, gold particles, magnetic labels, electrical readouts, density signals, etc.), and the like. In certain embodiments, the detectable label is a fluorescent label. Fluorescent labels are labeling moieties that are detectable by a fluorescence detector. For example, binding of a fluorescent label to an analyte of interest may allow the analyte of interest to be detected by a fluorescence detector. Examples of fluorescent labels include, but are not limited to, fluorescent molecules that fluoresce upon contact with a reagent, fluorescent molecules that fluoresce when irradiated with electromagnetic radiation (e.g., UV, visible light, x-rays, etc.), and the like.

Suitable fluorescent molecules (fluorophores) include, but are not limited to, fluorescein, fluorescein isothiocyanate, succinimidyl esters of carboxyfluorescein, succinimidyl esters of fluorescein, 5-isomer of fluorescein dichlorotriazine, caged carboxyfluorescein-alanine-carboxamide, Oregon Green 488, Oregon Green 514; Lucifer Yellow, acridine Orange, rhodamine, tetramethylrhodamine, Texas Red, propidium iodide, JC-1 (5,5′,6,6′-tetrachloro-1,1′,3,3′-tetraethylbenzimidazoylcarbocyanine iodide), tetrabromorhodamine 123, rhodamine 6G, TMRM (tetramethyl rhodamine methyl ester), TMRE (tetramethyl rhodamine ethyl ester), tetramethylrosamine, rhodamine B and 4-dimethylaminotetramethylrosamine, green fluorescent protein, blue-shifted green fluorescent protein, cyan-shifted green fluorescent protein, red-shifted green fluorescent protein, yellow-shifted green fluorescent protein, 4-acetamido-4′-isothiocyanatostilbene-2,2′disulfonic acid; acridine and derivatives, such as acridine, acridine isothiocyanate; 5-(2′-aminoethyl)aminonaphthalene-1-sulfonic acid (EDANS); 4-amino-N-[3-vinylsulfonyl)phenyl]naphth-alimide-3,5 disulfonate; N-(4-anilino-1-naphthyl)maleimide; anthranilamide; 4,4-difluoro-5-(2-thienyl)-4-bora-3a,4a diaza-5-indacene-3-propioni-c acid BODIPY; cascade blue; Brilliant Yellow; coumarin and derivatives: coumarin, 7-amino-4-methylcoumarin (AMC, Coumarin 120),7-amino-4-trifluoromethylcoumarin (Coumarin 151); cyanine dyes; cyanosine; 4′,6-diaminidino-2-phenylindole (DAPI); 5′,5″-dibromopyrogallol-sulfonaphthalein (Bromopyrogallol Red); 7-diethylamino-3-(4′-isothiocyanatophenyl)-4-methylcoumarin; diethylenetriaamine pentaacetate; 4,4′-diisothiocyanatodihydro-stilbene-2- ,2′-disulfonic acid; 4,4′-diisothiocyanatostilbene-2,2′-disulfonic acid; 5-(dimethylamino]naphthalene-1-sulfonyl chloride (DNS, dansylchloride); 4-dimethylaminophenylazophenyl-4′-isothiocyanate (DABITC); eosin and derivatives: eosin, eosin isothiocyanate, erythrosin and derivatives: erythrosin B, erythrosin, isothiocyanate; ethidium; fluorescein and derivatives: 5-carboxyfluorescein (FAM),5-(4,6-dichlorotriazin-2-yl)amino- -fluorescein (DTAF), 2′,7′dimethoxy-4′5′-dichloro-6-carboxyfluorescein (JOE), fluorescein, fluorescein isothiocyanate, QFITC, (XRITC); fluorescamine; IR144; IR1446; Malachite Green isothiocyanate; 4-methylumbelliferoneortho cresolphthalein; nitrotyrosine; pararosaniline; Phenol Red; B-phycoerythrin; o-phthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red); N,N,N′,N′-tetramethyl-6-carboxyrhodamine (TAMRA); tetramethyl rhodamine; tetramethyl hodamine isothiocyanate (TRITC); riboflavin; 5-(2′-aminoethyl)aminonaphthalene-1-sulfonic acid (EDANS), 4-(4′-dimethylaminophenylazo)benzoic acid (DABCYL), rosolic acid; CAL Fluor Orange 560; terbium chelate derivatives; Cy 3; Cy 5; Cy 5.5; Cy 7; IRD 700; IRD 800; La Jolla Blue; phthalo cyanine; and naphthalo cyanine, coumarins and related dyes, xanthene dyes such as rhodols, resorufins, bimanes, acridines, isoindoles, dansyl dyes, aminophthalic hydrazides such as luminol, and isoluminol derivatives, aminophthalimides, aminonaphthalimides, aminobenzofurans, aminoquinolines, dicyanohydroquinones, fluorescent europium and terbium complexes; combinations thereof, and the like. Suitable fluorescent proteins and chromogenic proteins include, but are not limited to, a green fluorescent protein (GFP), including, but not limited to, a GFP derived from Aequoria victoria or a derivative thereof, e.g., a “humanized” derivative such as Enhanced GFP; a GFP from another species such as Renilla reniformis, Renilla mulleri, or Ptilosarcus guernyi; “humanized” recombinant GFP (hrGFP); any of a variety of fluorescent and colored proteins from Anthozoan species; combinations thereof; and the like.

In certain embodiments, the method includes introducing a fluid sample into a microfluidic device. Introducing the fluid sample into the microfluidic device may include directing the sample through a separation medium to produce a separated sample. In some cases, the separated sample is produced by electrophoresis (e.g., moving boundary electrophoresis) as the sample traverses the separation medium, as described above. The separated sample may include distinct detectable regions of analytes, where each region includes one or more analytes that have substantially similar properties, such as molecular weight, size, charge (e.g., charge to mass ratio), isoelectric point, etc.

In certain embodiments, the method includes detecting analyte fronts as they traverse through the separation medium. For example, the method may include detecting differentially migrating analytes in the channel by a moving boundary electrophoresis (MBE) protocol to assay the fluid sample for the presence of the analyte. As described above, as a sample traverses the separation medium, the analytes in the sample may be concentrated into detectable regions. Each detectable region may have a front or leading edge (i.e., downstream boundary) where the concentration of the analyte is greater than the concentration of the analyte in the adjacent region (i.e., the region immediately downstream from the detectable region of the analyte). The presence of the analyte may be determined by detecting the boundary between adjacent regions. For example, the method may include detecting a first analyte and a second analyte as the first and second analytes traverse through the separation medium. As the sample traverses the separation medium, the first and second analytes may separate into a first region where the concentration of the first analyte is greater and a second region where the concentration of the second analyte is greater. In some instances, the first analyte may traverse the separation medium faster than the second analyte, thus the first region may be downstream from the second region. In these instances, the method may include detecting the boundary between the first and second regions. As the analytes traverse the separation medium, the boundary between the first and second regions of analytes correspondingly traverses the separation medium, and the method may include detecting the boundary over time as the boundary traverses the separation medium during the assay. Fluid samples may include 1 or more, 2 or more, 3 or more, 4 or more, 5 or more, 6 or more, 7 or more, 8 or more, 9 or more, 10 or more, or even greater numbers of analytes, and the method may include detecting boundaries between each of these adjacent regions of analytes.

In some embodiments, the methods include the uniplex analysis of an analyte in a sample. By “uniplex analysis” is meant that a sample is analyzed to detect the presence of one analyte in the sample. For example, a sample may include a mixture of an analyte of interest and other molecular entities that are not of interest. In some cases, the methods include the uniplex analysis of the sample to determine the presence of the analyte of interest in the sample mixture.

Certain embodiments include the multiplex analysis of two or more analytes in a sample. By “multiplex analysis” is meant that the presence two or more distinct analytes, in which the two or more analytes are different from each other, is determined. For example, analytes may include detectable differences in their molecular weight, size, charge (e.g., mass to charge ratio), isoelectric point, and the like. In some instances, the number of analytes is greater than 2, such as 4 or more, 6 or more, 8 or more, etc., up to 20 or more, e.g., 50 or more, including 100 or more, distinct analytes. In certain embodiments, the methods include the multiplex analysis of 2 to 100 distinct analytes, such as 4 to 50 distinct analytes, including 4 to 20 distinct analytes.

In certain embodiments, the method is an automated method. As such, the method may include a minimum of user interaction with the microfluidic devices and systems after introducing the sample into the microfluidic device. For example, the step of directing the sample through the separation medium to produce a separated sample may be performed by the microfluidic device and system, such that the user need not manually perform this step. In some cases, the automated method may facilitate a reduction in the total assay time. For example, embodiments of the method, including the separation and detection of analytes in a sample, may be performed in 30 min or less, such as 20 min or less, including 15 min or less, or 10 min or less, or 5 min or less, or 2 min or less, or 1 min or less, or 30 seconds or less, or 20 seconds or less, or 10 seconds or less.

### Systems

Aspects of the present disclosure include a system for detecting an analyte in a sample. In some instances, the system includes a microfluidic device as described herein, such as a microfluidic device that includes a single electrophoretic channel containing a separation medium.

In certain embodiments, the microfluidic system includes a processor. The processor may be configured to detect an analyte in a sample. As described herein, during use, the microfluidic device may separate analytes in a sample based on a moving boundary electrophoresis (MBE) protocol. In some cases, differences in the distance and/or speed of migration of different analytes as they traverse the separation medium may be detected in order to distinguish one analyte from another. As such, in some instances, the processor of the system may be configured to detect these differentially migrating analytes in the separation medium by a moving boundary electrophoresis (MBE) protocol. In some cases, the processor includes a computer. The processor may be configured to execute instructions (e.g., a program) stored in a memory device of the system. The instructions, when executed by the processor, may cause the processor to detect one or more analytes in the sample, for instance to detect differentially migrating analytes in the separation medium by a MBE protocol as described above.

In certain embodiments, the microfluidic system includes a power source. The power source may be configured to generate an electric field and apply the electric field to the microfluidic device. For example, the power source may be configured to apply the electric field to the separation channel. The power source may be configured to electrokinetically transport the analytes and moieties in a sample through the various media (e.g., buffer, separation medium, etc.) in the microfluidic device. In certain instances, the power source may be proximal to the microfluidic device, such as arranged on the microfluidic device. In some cases, the power source is positioned a distance from the microfluidic device. For example, the power source may be incorporated into a microfluidic system for detecting an analyte, as described herein. In some instances, the electric field is low power, having a power consumption for a given separation in some instances of 50 μW or less, or 40 μW or less, or 30 μW or less, such as 20 μW or less, or 15 μW or less, including 10 μW or less, e.g., 5 μW or less, including 3 μW or less, or even 2 μW or less, or 1 μW or less. In some cases, the power is 3 μW or less. The power may be provided by a low voltage power source, where in some instances, the power is provided by a low voltage power source that is 100 V or less, such as 50 V or less, including 25 V or less, e.g., 15 V or less, such as 10 V or less, e.g. a 9 V battery.

In some cases, the applied electric field may be aligned with the directional axis of the separation flow path of the separation medium. As such, the applied electric field may be configured to electrokinetically transport the analytes and moieties in a sample through the separation medium. In certain embodiments, the system includes a power source configured to apply an electric field such that analytes and/or moieties in the sample are electrokinetically transported from one end of the separation medium (e.g., the upstream end) to the opposite end of the separation medium (e.g., the downstream end). In some instances, the power source is configured to apply an electric field with a strength ranging from 10 V/cm to 1000 V/cm, such as from 100 V/cm to 800 V/cm, including from 200 V/cm to 600 V/cm, or from 200 V/cm to 500 V/cm, or from 200 V/cm to 400 V/cm. In certain cases, the power source is configured to apply an electric field with a strength of 100 V/cm. In some cases, the power source is configured to apply an electric field with a strength of 300 V/cm.

In certain embodiments, the power source includes voltage shaping components. In some cases, the voltage shaping components are configured to control the strength of the applied electric field, such that the applied electric field strength is substantially uniform across the separation medium. The voltage shaping components may facilitate an increase in the resolution of the analytes in the sample. For instance, the voltage shaping components may facilitate a reduction in non-uniform movement of the sample through the separation medium. In addition, the voltage shaping components may facilitate a minimization in the dispersion of the bands of analytes as the analytes traverse the separation medium.

The microfluidic system may also include a detector. In some cases, the detector is a detector configured to detect a detectable label. As described above, the detectable label may be a fluorescent label. For example, the fluorescent label can be contacted with electromagnetic radiation (e.g., visible, UV, x-ray, etc.), which excites the fluorescent label and causes the fluorescent label to emit detectable electromagnetic radiation (e.g., visible light, etc.). The emitted electromagnetic radiation may be detected with an appropriate detector to determine the presence of the analyte in the separation medium.

In some instances, the detector may be configured to detect emissions from a fluorescent label, as described above. In certain cases, the detector includes a photomultiplier tube (PMT), a charge-coupled device (CCD), an intensified charge-coupled device (ICCD), a complementary metal-oxide-semiconductor (CMOS) sensor, a visual colorimetric readout, a photodiode, and the like.

Systems of the present disclosure may include various other components as desired. For example, the systems may include fluid handling components, such as microfluidic fluid handling components. The fluid handling components may be configured to direct one or more fluids through the microfluidic device. In some instances, the fluid handling components are configured to direct fluids, such as, but not limited to, sample solutions, buffers (e.g., release buffers, wash buffers, electrophoresis buffers, etc.), and the like. In certain embodiments, the microfluidic fluid handling components are configured to deliver a fluid to the separation medium of the microfluidic device, such that the fluid contacts the separation medium. For example, the microfluidic fluid handling components may be configured to deliver a fluid to a fluid input port of the microfluidic device. In certain instances, the microfluidic fluid handling components are configured to deliver small volumes of fluid, such as 1 mL or less, such as 500 μL or less, including 100 μL or less, for example 50 μL or less, or 25 μL or less, or 10 μL or less, or 5 μL or less, or 1 μL or less. In certain instances, the system does not include pressure-driven microfluidic fluid handling components, such that the system does not include components that transport fluid through the microfluidic device by creating a pressure differential in the device. In some cases, the microfluidic handling components electrokinetically transport fluid through the microfluidic device, rather than by using pressure.

In certain embodiments, the subject system is a biochip (e.g., a biosensor chip). By “biochip” or “biosensor chip” is meant a microfluidic system that includes a substrate surface which displays one or more distinct microfluidic devices on the substrate surface. In certain embodiments, the microfluidic system includes a substrate surface with an array of microfluidic devices.

An “array” includes any two-dimensional or substantially two-dimensional (as well as a three-dimensional) arrangement of addressable regions, e.g., spatially addressable regions. An array is “addressable” when it has multiple devices positioned at particular predetermined locations (e.g., “addresses”) on the array. Array features (e.g., devices) may be separated by intervening spaces. Any given substrate may carry one, two, four or more arrays disposed on a front surface of the substrate. Depending upon the use, any or all of the arrays may be the same or different from one another and each may contain multiple distinct microfluidic devices. An array may contain one or more, including two or more, four or more, 8 or more, 10 or more, 50 or more, or 100 or more microfluidic devices. In certain embodiments, the microfluidic devices can be arranged into an array with an area of less than 10 cm², or less than 5 cm², e.g., less than 1 cm², including less than 50 mm², less than 20 mm², such as less than 10 mm², or even smaller. For example, microfluidic devices may have dimensions in the range of 10 mm×10 mm to 200 mm×200 mm, including dimensions of 100 mm×100 mm or less, such as 50 mm×50 mm or less, for instance 25 mm×25 mm or less, or 10 mm×10 mm or less, or 5 mm×5 mm or less, for instance, 1 mm×1 mm or less.

Arrays of microfluidic devices may be arranged for the multiplex analysis of samples. For example, multiple microfluidic devices may be arranged in series, such that a sample may be analyzed for the presence of several different analytes in a series of microfluidic devices. In certain embodiments, multiple microfluidic devices may be arranged in parallel, such that two or more samples may be analyzed at substantially the same time.

Aspects of the systems include that the microfluidic devices may be configured to consume a minimum amount of sample while still producing detectable results. For example, the system may be configured to use a sample volume of 100 μL or less, such as 75 μL or less, including 50 μL or less, or 25 μL or less, or 10 μL or less, for example, 5 μL or less, 2 μL or less, or 1 μL or less while still producing detectable results. In certain embodiments, the system is configured to have a detection sensitivity of 1 nM or less, such as 500 μM or less, including 100 μM or less, for instance, 1 μM or less, or 500 fM or less, or 250 fM or less, such as 100 fM or less, including 50 fM or less, or 25 fM or less, or 10 fM or less. In some instances, the system is configured to be able to detect analytes at a concentration of 1 μg/mL or less, such as 500 ng/mL or less, including 100 ng/mL or less, for example, 10 mg/mL or less, or 5 ng/mL or less, such as 1 ng/mL or less, or 0.1 ng/mL or less, or 0.01 ng/mL or less, including 1 pg/mL or less. In certain embodiments, the system has a dynamic range from 10⁻¹⁸ M to 10 M, such as from 10⁻¹⁵ M to 10⁻³ M, including from 10⁻¹² M to 10⁻⁶ M.

In certain embodiments, the microfluidic system is configured to achieve a detectable separation resolution between analytes in a fluid sample. By “separation resolution” is meant a sufficient separation (e.g., difference in migration distance through the separation medium) between two analytes, such that the two analytes may be detectably distinguished from each other. In some instances, the separation resolution is measured as the mean distance between neighboring peaks normalized by the average peak width. In certain cases, a separation resolution greater than 1 indicates that the two analytes are sufficiently separated from each other to be detectably distinguished from each other.

In certain embodiments, the microfluidic devices are operated at a temperature ranging from 1° C. to 100° C., such as from 5° C. to 75° C., including from 10° C. to 50° C., or from 20° C. to 40° C. In some instances, the microfluidic devices are operated at a temperature ranging from 35° C. to 40° C.

### Utility

The subject devices, systems and methods find use in a variety of different applications where determination of the presence or absence, and/or quantification of one or more analytes in a sample is desired. In certain embodiments, the methods are directed to the detection of nucleic acids, proteins, or other biomolecules in a sample. The methods may include the detection of a set of biomarkers, e.g., two or more distinct protein biomarkers, in a sample. For example, the methods may be used in the rapid, clinical detection of two or more disease biomarkers in a biological sample, e.g., as may be employed in the diagnosis of a disease condition in a subject, in the ongoing management or treatment of a disease condition in a subject, etc.

In certain embodiments, the subject devices, systems and methods find use in detecting biomarkers. In some cases, the subject devices, systems and methods may be used to detect the presence or absence of particular biomarkers, as well as an increase or decrease in the concentration of particular biomarkers in blood, plasma, serum, or other bodily fluids or excretions, such as but not limited to urine, blood, serum, plasma, saliva, semen, prostatic fluid, nipple aspirate fluid, lachrymal fluid, perspiration, feces, cheek swabs, cerebrospinal fluid, cell lysate samples, amniotic fluid, gastrointestinal fluid, biopsy tissue (e.g., samples obtained from laser capture microdissection (LCM)), and the like.

The presence or absence of a biomarker or significant changes in the concentration of a biomarker can be used to diagnose disease risk, presence of disease in an individual, or to tailor treatments for the disease in an individual. For example, the presence of a particular biomarker or panel of biomarkers may influence the choices of drug treatment or administration regimes given to an individual. In evaluating potential drug therapies, a biomarker may be used as a surrogate for a natural endpoint such as survival or irreversible morbidity. If a treatment alters the biomarker, which has a direct connection to improved health, the biomarker can serve as a surrogate endpoint for evaluating the clinical benefit of a particular treatment or administration regime. Thus, personalized diagnosis and treatment based on the particular biomarkers or panel of biomarkers detected in an individual are facilitated by the subject devices, systems and methods. Furthermore, the early detection of biomarkers associated with diseases is facilitated by the high sensitivity of the subject devices and systems, as described above. Due to the capability of detecting multiple biomarkers on a single biochip, combined with sensitivity, scalability, and ease of use, the presently disclosed microfluidic devices, systems and methods finds use in portable and point-of-care or near-patient molecular diagnostics.

In certain embodiments, the subject devices, systems and methods find use in detecting biomarkers for a disease or disease state. In some cases, the disease is a cellular proliferative disease, such as but not limited to, a cancer, a tumor, a papilloma, a sarcoma, or a carcinoma, and the like. In certain instances, the subject devices, systems and methods find use in detecting biomarkers for the characterization of cell signaling pathways and intracellular communication for drug discovery and vaccine development. For example, the subject devices, systems and methods find use in detecting the presence of a disease, such as a cellular proliferative disease, such as a cancer, tumor, papilloma, sarcoma, carcinoma, or the like. In certain instances, particular biomarkers of interest for detecting cancer or indicators of a cellular proliferative disease include, but are not limited to the following: prostate specific antigen (PSA), which is a prostate cancer biomarker; C-reactive protein, which is an indicator of inflammation; transcription factors, such as p53, which facilitates cell cycle and apoptosis control; polyamine concentration, which is an indicator of actinic keratosis and squamous cell carcinoma; proliferating cell nuclear antigen (PCNA), which is a cell cycle related protein expressed in the nucleus of cells that are in the proliferative growth phase; growth factors, such as IGF-I; growth factor binding proteins, such as IGFBP-3; micro-RNAs, which are single-stranded RNA molecules of about 21-23 nucleotides in length that regulate gene expression; carbohydrate antigen CA19.9, which is a pancreatic and colon cancer biomarker; cyclin-dependent kinases; epithelial growth factor (EGF); vascular endothelial growth factor (VEGF); protein tyrosine kinases; over-expression of estrogen receptor (ER) and progesterone receptor (PR); and the like. For example, the subject devices, systems and methods may be used to detect and/or quantify the amount of endogenous prostate specific antigen (PSA) in diseased, healthy and benign samples.

In certain embodiments, the subject devices, systems and methods find use in detecting biomarkers for an infectious disease or disease state. In some cases, the biomarkers can be molecular biomarkers, such as but not limited to proteins, nucleic acids, carbohydrates, small molecules, and the like. For example, the subject devices, systems and methods may be used to monitor HIV viral load and patient CD4 count for HIV/AIDS diagnosis and/or therapy monitoring by functionalizing the sensor surface with antibodies to HIV capsid protein p24, glycoprotiens 120 and 41, CD4+ cells, and the like. Particular diseases or disease states that may be detected by the subject devices, systems and methods include, but are not limited to, bacterial infections, viral infections, increased or decreased gene expression, chromosomal abnormalities (e.g., deletions or insertions), and the like. For example, the subject devices, systems and methods can be used to detect gastrointestinal infections, such as but not limited to, aseptic meningitis, botulism, cholera, E. coli infection, hand-foot-mouth disease, helicobacter infection, hemorrhagic conjunctivitis, herpangina, myocaditis, paratyphoid fever, polio, shigellosis, typhoid fever, vibrio septicemia, viral diarrhea, etc. In addition, the subject devices, systems and methods can be used to detect respiratory infections, such as but not limited to, adenovirus infection, atypical pneumonia, avian influenza, swine influenza, bubonic plague, diphtheria, influenza, measles, meningococcal meningitis, mumps, parainfluenza, pertussis (i.e., whooping cough), pneumonia, pneumonic plague, respiratory syncytial virus infection, rubella, scarlet fever, septicemic plague, severe acute respiratory syndrome (SARS), tuberculosis, etc. In addition, the subject devices, systems and methods can be used to detect neurological diseases, such as but not limited to, Creutzfeldt-Jakob disease, bovine spongiform encephalopathy (i.e., mad cow disease), Parkinson's disease, Alzheimer's disease, rabies, etc. In addition, the subject devices, systems and methods can be used to detect urogenital diseases, such as but not limited to, AIDS, chancroid, Chlamydia, condyloma accuminata, genital herpes, gonorrhea, lymphogranuloma venereum, non-gonococcal urethritis, syphilis, etc. In addition, the subject devices, systems and methods can be used to detect viral hepatitis diseases, such as but not limited to, hepatitis A, hepatitis B, hepatitis C, hepatitis D, hepatitis E, etc. In addition, the subject devices, systems and methods can be used to detect hemorrhagic fever diseases, such as but not limited to, Ebola hemorrhagic fever, hemorrhagic fever with renal syndrome (HFRS), Lassa hemorrhagic fever, Marburg hemorrhagic fever, etc. In addition, the subject devices, systems and methods can be used to detect zoonosis diseases, such as but not limited to, anthrax, avian influenza, brucellosis, Creutzfeldt-Jakob disease, bovine spongiform encephalopathy (i.e., mad cow disease), enterovirulent E. coli infection, Japanese encephalitis, leptospirosis, Q fever, rabies, sever acute respiratory syndrome (SARS), etc. In addition, the subject devices, systems and methods can be used to detect arbovirus infections, such as but not limited to, Dengue hemorrhagic fever, Japanese encephalitis, tick-borne encephalitis, West Nile fever, Yellow fever, etc. In addition, the subject devices, systems and methods can be used to detect antibiotics-resistance infections, such as but not limited to, Acinetobacter baumannii, Candida albicans, Enterococci sp., Klebsiella pneumoniae, Pseudomonas aeruginosa, Staphylococcus aureus, etc. In addition, the subject devices, systems and methods can be used to detect vector-borne infections, such as but not limited to, cat scratch disease, endemic typhus, epidemic typhus, human ehrlichosis, Japanese spotted fever, louse-borne relapsing fever, Lyme disease, malaria, trench fever, Tsutsugamushi disease, etc. Similarly, the subject devices, systems and methods can be used to detect cardiovascular diseases, central nervous diseases, kidney failures, diabetes, autoimmune diseases, and many other diseases.

The subject device, systems and methods find use in diagnostic assays, such as, but not limited to, the following: detecting and/or quantifying biomarkers, as described above; screening assays, where samples are tested at regular intervals for asymptomatic subjects; prognostic assays, where the presence and or quantity of a biomarker is used to predict a likely disease course; stratification assays, where a subject's response to different drug treatments can be predicted; efficacy assays, where the efficacy of a drug treatment is monitored; and the like.

The subject devices, systems and methods also find use in validation assays. For example, validation assays may be used to validate or confirm that a potential disease biomarker is a reliable indicator of the presence or absence of a disease across a variety of individuals. The short assay times for the subject devices, systems and methods may facilitate an increase in the throughput for screening a plurality of samples in a minimum amount of time.

In some instances, the subject devices, systems and methods can be used without requiring a laboratory setting for implementation. In comparison to typical analytic research laboratory equipment, the subject devices and systems provide comparable analytic sensitivity in a portable, hand-held system, such as a portable, hand-held analysis device or a cellular phone compatible device. In some cases, the weight and operating cost are less than the typical stationary laboratory equipment. The subject systems and devices may be integrated into a single apparatus, such that all the steps of the assay, including separation, labeling and detecting of an analyte of interest, may be performed by a single apparatus. As such, a single apparatus may include a microfluidic device, a detector, a power source, a processor, etc. as described above. For example, in some instances, there are no separate apparatuses for separation, labeling and detecting of an analyte of interest. In certain embodiments, the apparatus may be configured to be reusable, such that a microfluidic biochip containing one or more microfluidic devices as described above is configured to be removable from the apparatus and replaceable with a second biochip after use of the first biochip. The biochips may be disposable, or washed and reused. In addition, the subject systems and devices can be utilized in a home setting for over-the-counter home testing by a person without medical training to detect one or more analytes in samples. The subject systems and devices may also be utilized in a clinical setting, e.g., at the bedside, for rapid diagnosis or in a setting where stationary research laboratory equipment is not provided due to cost or other reasons.

### Kits

Aspects of the present disclosure additionally include kits that have a microfluidic device as described in detail herein. The kits may further include a buffer. For instance, the kit may include a buffer, such as an electrophoretic buffer, a sample buffer, and the like. The kits may further include additional reagents, such as but not limited to, release agents, denaturing agents, refolding agents, detergents, detectable labels (e.g., fluorescent labels, colorimetric labels, chemiluminescent labels, multicolor reagents, enzyme-linked reagents, avidin-streptavidin associated detection reagents, radiolabels, gold particles, magnetic labels, etc.), and the like.

In certain embodiments, the kits include a power source. As described herein, the power source may be configured to generate an electric field and apply the electric field to the microfluidic device. For example, the power source may be configured to apply the electric field to the separation channel. The power source may be a low voltage power source, where in some instances, the power is provided by a low voltage power source that is 100 V or less, such as 50 V or less, including 25 V or less, e.g., 15 V or less, such as 10 V or less, e.g. a 9 V battery. In certain cases, the power source may include a battery, such as a 9 V battery as described above.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Another means would be a computer readable medium, e.g., diskette, CD, DVD, Blu-Ray, computer-readable memory (e.g., flash memory device), etc., on which the information has been recorded or stored. Yet another means that may be present is a website address which may be used via the Internet to access the information at a removed site. Any convenient means may be present in the kits.

As can be appreciated from the disclosure provided above, embodiments of the present invention have a wide variety of applications. Accordingly, the examples presented herein are offered for illustration purposes and are not intended to be construed as a limitation on the invention in any way. Those of ordinary skill in the art will readily recognize a variety of noncritical parameters that could be changed or modified to yield essentially similar results. Thus, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric.

### EXAMPLES

### Example 1

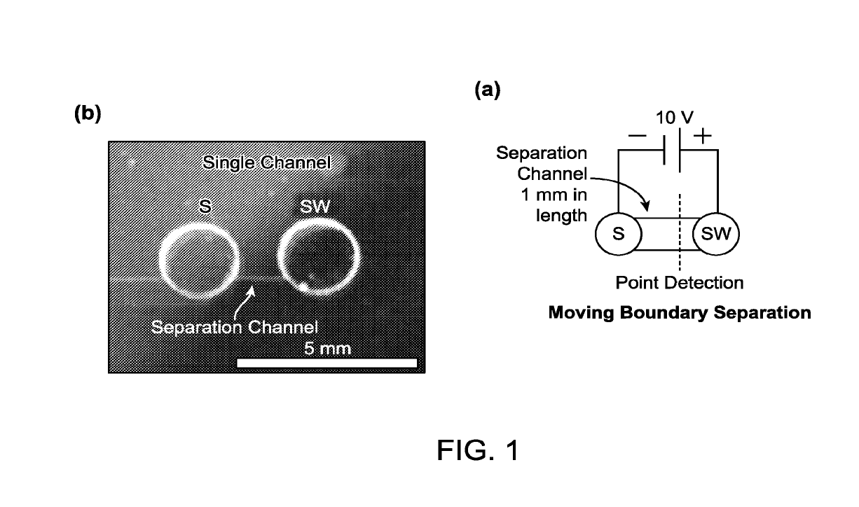

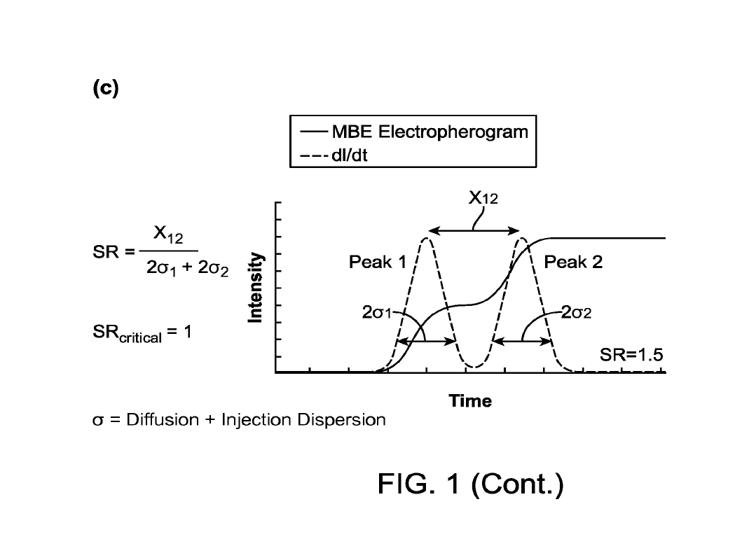

Experiments were performed to test an electrophoretic assay designed for use with a standard 9V battery (FIG. 1). In the figures, S is the sample port (e.g., the fluid input port), and SW is the sample waste port (e.g., the fluid output port). The electrophoretic assay used a moving boundary electrophoresis (MBE) protocol. With this separation technique, an immunoassay was performed using a single, short (300 μm) separation channel with two terminal fluid reservoirs to inject a moving boundary (front of material) (FIG. 1a). In contrast, conventional approaches have used zone electrophoresis (ZE) where a ‘plug’ of material is defined in an injection channel and then separated in an orthogonal separation channel.

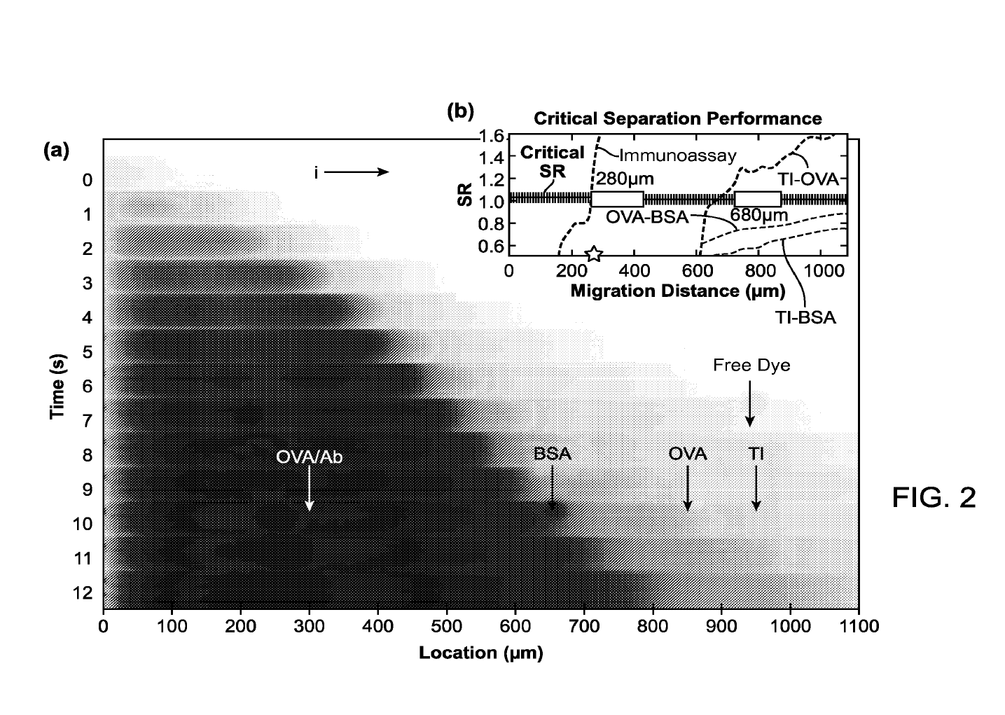

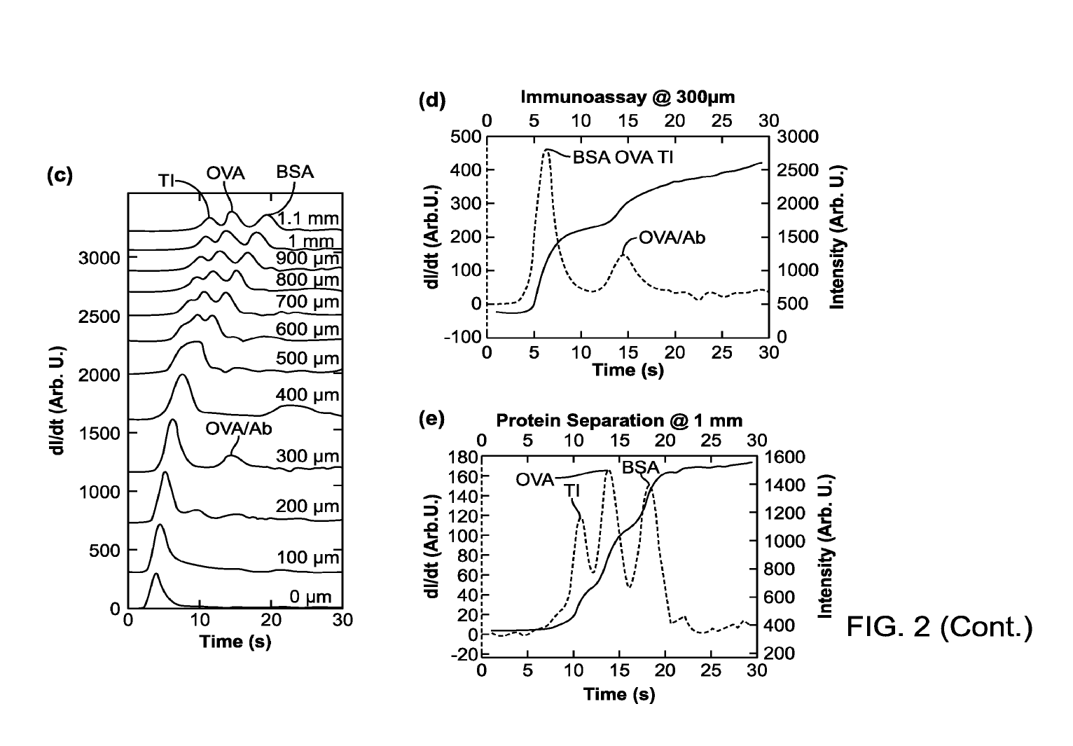

Embodiments of the present disclosure are configured to detect differentially migrating protein fronts (FIG. 2). In certain embodiments, the microfluidic devices facilitate a reduction in injection dispersion (band broadening) of the analyte sample. In certain embodiments, the separation channel includes an interface between the fluid and separation medium (e.g., a liquid/gel interface) (defined during photopatterning of the separation medium).

### Materials and Methods

Materials

Solutions of 30% (29:1) acrylamide/bis-acrylamide, 3-(trimethoxysilyl)-propyl methacrylate (98%), glacial acetic acid and methanol were obtained from Sigma Aldrich (St. Louis, Mo.). Photoinitiator 2,2-azobis[2-methyl-N-(2-hydroxyethyl) propionamide] (VA-086) was obtained from Wako Chemical (Richmond, Va.). Alexa Fluor 488 conjugated Trypsin Inhibitor (TI), Ovalubmin (OVA), and Bovine Serum Albumin (BSA) were obtained from Sigma. Polyclonal OVA antibody was obtained from Abcam (ab1221). Purified human serum was obtained from Calbiochem (San Diego, Calif.). Trisglycine (10×) native electrophoresis buffer was obtained from Bio-Rad Laboratories (Hercules, Calif.).

Device Preparation

Glass microfluidic chips with 1 cm single channels were fabricated using a wet etch to form a 10 μm×70 μm channel cross-section by Caliper Life Sciences (Hopkinton, Mass.). To form 1 mm channels a Cameron Micro Drill Press (Sonora, Calif.) was used with a 2.1 mm diameter Triple Ripple drill bit.

The glass microchannel was first incubated in 1 M NaOH for 10 minutes and then flushed with DI water and purged with a vacuum. A 2:3:5 (v/v/v) mixture of 3-(trimethoxysilyl)-propyl methacrylate, glacial acetic acid and DI water was introduced and allowed to incubate for 30 minutes. After the incubation, the channel was rinsed with methanol and DI water and then purged with a vacuum.

Gel Fabrication

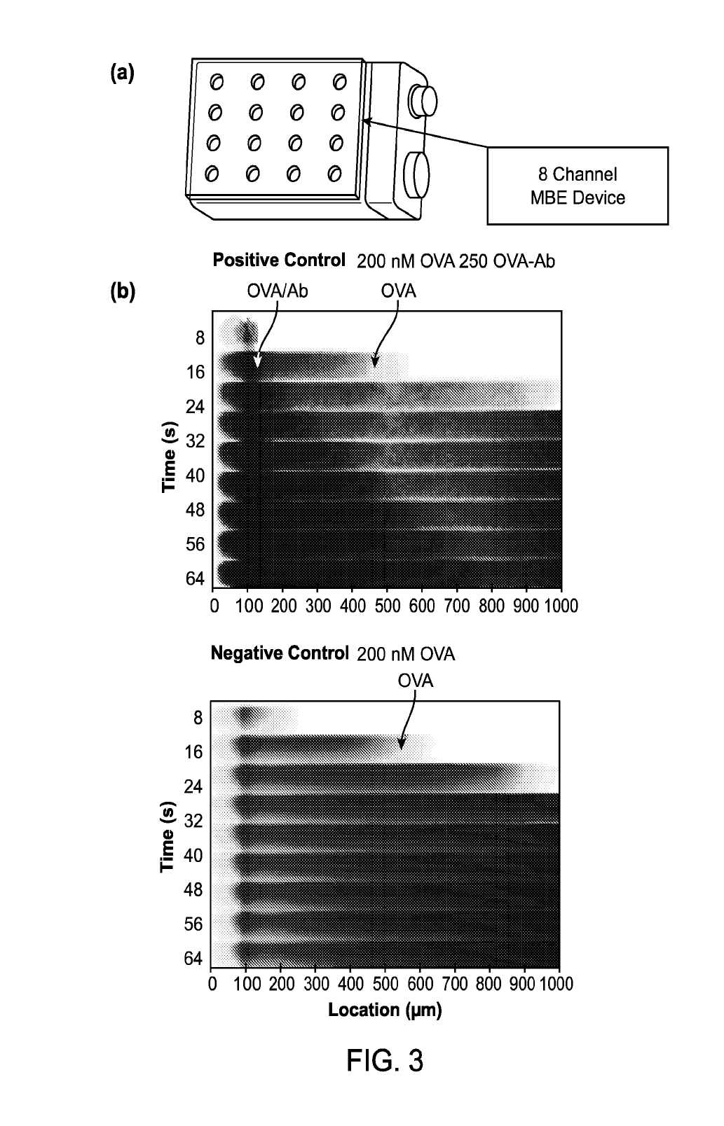

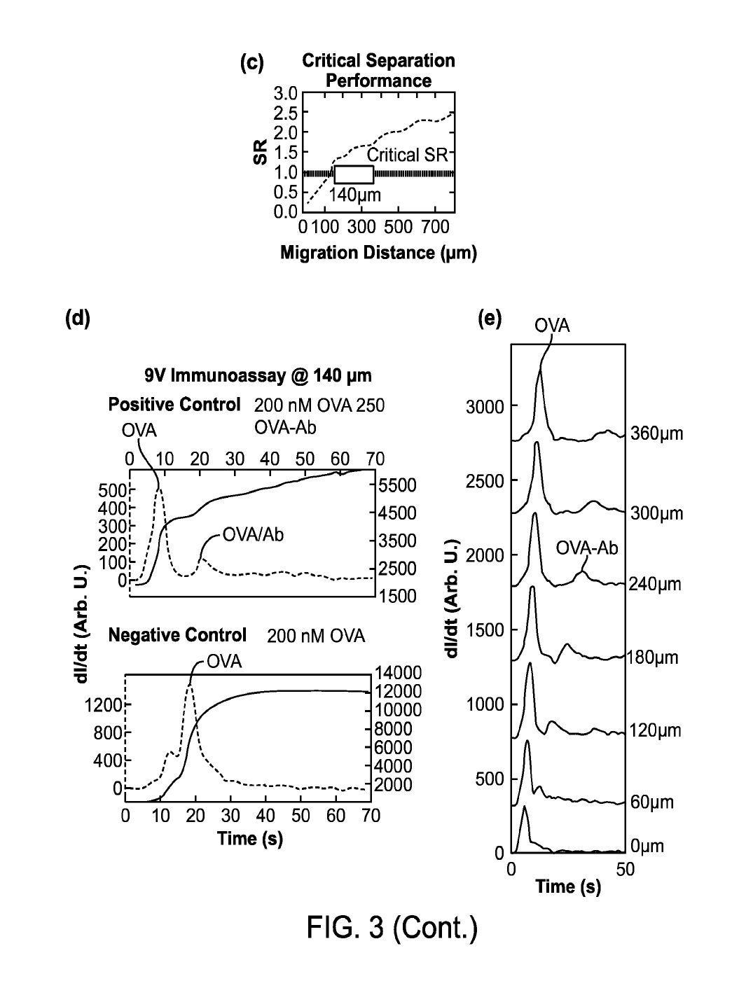

Gel precursor consisted of a 10% or 6% (w/v) acrylamide concentration for FIG. 2 or 3, and 4, respectively, with a bis-acrylamide crosslinker ratio of 3% (w/w), and 0.2% (w/v) VA-086 dissolved in 1× tris/glycine. After degassing, 3 μl of gel precursor was added to a well and allowed to fill the channel through capillary action. Once filled, an additional 3 μl of gel precursor was added to the opposite well. Photopolymerization was carried out above a Blak-Ray® UV lamp at 10 mW/cm² for 10 minutes. After 1 minute of exposure and without removing the chip, 10 μl of 1× tris/glycine buffer was pumped in and out of the sample well four times. Buffer addition prevented polymerization in the well, creating a gel/buffer interface within the microchannel. After polymerization, the device was stored in 1× tris/glycine at 4° C. until use.

### EXPERIMENTAL

### Testing Procedure

To perform an assay, the sample was pipetted directly into the sample well then was immediately electrophoretically driven into the single channel.

For initial assay characterization, current monitoring and the application of the driving voltage was performed with a Caliper high voltage power supply. In the low power experiment (described in more detail below), a standard off-the-shelf 9V Energizer® battery was used. A 50 kΩ resistor was placed in series with the microchannel with its voltage drop measured by an Agilent (Santa Clara, Calif.) multimeter to monitor current.

Protein fronts were detected using an inverted epiflourescence microscope (Olympus IX-70) equipped with a 100V mercury arc lamp, a 10× objective, and a Peltiercooled charge-coupled device (CCD) camera (CoolSNAP HQ2, Roper Scientific, Trenton, N.J.). Images were recorded using MetaMorph® acquisition software and post-processing was done in ImageJ (NIH) and MATLAB®.

Separation Efficiency

In both the protein separations and immunoassays shown, the ability to resolve two analytes was quantified through a ‘separation resolution’ parameter (SR, the mean distance between neighboring peaks normalized by the average peak width). A SR>1 indicated a detectable separation. The ‘critical separation length’, or the migration distance required to achieve a SR>1 was also determined. As the critical separation length was reduced, the channel length needed to achieve a detectable separation also decreased. In certain embodiments, this facilitated a reduction in applied voltage and the completion of a low power immunoassay (see e.g., FIG. 3).

### Results

Rapid Protein Separation and Immunoassay

A combined immunoassay and protein separation was performed in a 10% acrylamide gel at 300V/cm, as shown in FIG. 2. FIG. 2(a) depicts the time evolution of fluorescence intensity as the proteins migrated through the polyacrylamide sieving matrix. The CCD images are false color, allowing for the protein fronts to be visualized. FIG. 2(b) shows that the immunoassay met the critical SR at 280 μm of separation length and 15 s while the TI and BSA separated at 680 μm of separation length and 14 s.

The derivative of the fluorescent intensity was taken at 100 μm intervals along the channel, and are shown in a staggered plot in FIG. 2(c). By examining the derivative at increasing distances along the channel the dynamics of the separation was visualized.

Low Power Immunoassay

Experiments were performed using a single channel microfluidic device with a 1 mm channel (FIG. 1(b)). The driving electric field was inversely proportional to channel length, allowing for a 1:1 reduction in voltage (and power) with a reduction in channel length.

FIG. 3 shows an on-chip immunoassay powered by an off-the-shelf 9V battery to demonstrate a 3 μW immunoassay. The immunoassay was completed in 25 s and 140 μm from the solution-gel interface, as verified with negative controls (FIGS. 3(b) and (c)). FIG. 3(d) shows a comparison between the positive and negative control at 140 μm into the gel. In the positive control the OVA protein and its immune complex were visible in the electropherogram and in the corresponding derivatives while only the OVA protein was seen in the negative control.

Immunoassay in Serum

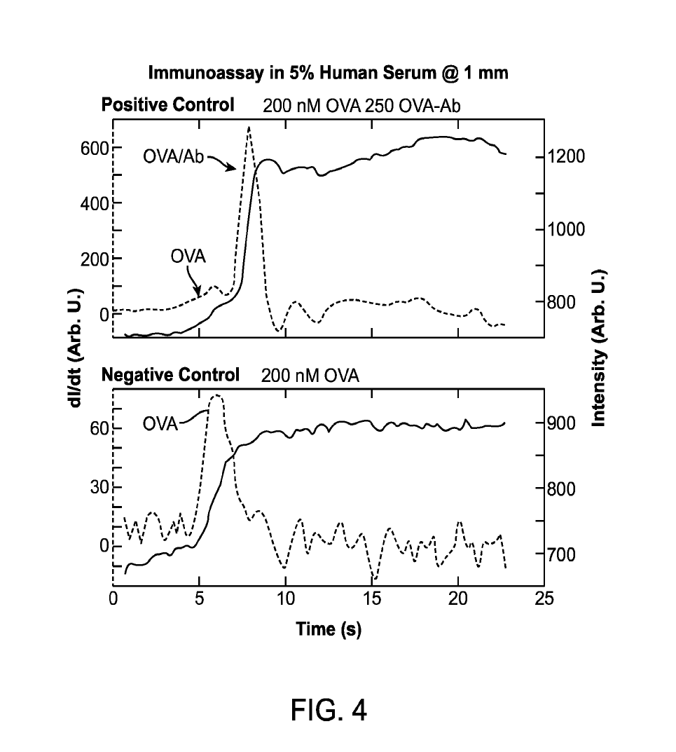

Experiments were performed on a complex sample. An immunoassay was performed with 5% human serum in the background electrolyte. FIG. 4 shows a graph for a MBE immunoassay of 5% human serum. FIG. 4 shows positive and negative controls for the OVA immunoassay at 1 mm from the solution/gel interface. Two fronts were observed in the positive control and only one front was observed in the negative control. This result indicates that the MBE separation method was useful for the analysis of complex samples (e.g., non-invasive diagnostic fluids). The multiple fronts in the positive control were repeatable and not present in the negative control. They were likely due to non-specific binding from the polyclonal antibody.

### Example 2

### Introduction

Experiments were performed using a single-inlet, single-outlet microchannel powered by voltage control (no pumps, valves, injectors). A moving boundary electrophoresis (MBE) protocol was used to separate analytes in a fluid sample. Injection dispersion was minimized during sample injection. To reduce injection dispersion, a photopatterned free solution-polyacrylamide gel (PAG) stacking interface at the upstream end of the MBE microchannel was used. The nanoporous PAG molecular sieve physically reduced the mobility of the analytes and moieties in the sample which facilitated enrichment and sharpening of the analyte fronts as analytes entered the microchannel. Various PAG configurations were characterized, with injection dispersion reduced by 85% or more. Experiments were also performed to analyze a model protein sample, and microfluidic PAG MBE baseline resolved the analytes in 5 s and in a separation distance of 1 mm or less. PAG MBE thus performed electrophoretic assays with minimal interfacing and sample handling, while maintaining separation performance. Experiments were also performed using a short separation channel length (1.3 mm) to demonstrate an electrophoretic immunoassay (EIA) powered with an off-the-shelf 9 V battery. The electrophoretic immunoassay consumed less than 3 μW of power and was completed in 30 s. The experiments are described in more detail below.

### Materials and Methods

Reagents and Protein Samples

Solutions of 30% (w/v) (29:1) acrylamide/bis-acrylamide, 3-(trimethoxysilyl)-propyl methacrylate (98%), glacial acetic acid and methanol were obtained from Sigma Aldrich (St. Louis, Mo.). Photoinitiator 2,2-azobis[2-methyl-N-(2-hydroxyethyl) propionamide] (VA-086) was obtained from Wako Chemical (Richmond, Va.). AlexaFluor 488 conjugated Trypsin Inhibitor (TI*), Ovalbumin (OVA*), and Bovine Serum Albumin (BSA*) were obtained from Sigma. Polyclonal OVA antibody was obtained from Abcam (ab1221). Tris-glycine (10×) native electrophoresis buffer was obtained from Bio-Rad Laboratories (Hercules, Calif.). The ‘protein ladder’ used in the experiments included 100 nM TI, OVA, and BSA fluorescently labeled with AlexaFluor 488 in Tris-glycine buffer (pH 8.3).

Device Fabrication and Operation

Straight 1 cm, 10 μm×70 μm glass microfluidic channels were fabricated by a foundry service (Caliper Life Sciences, Hopkinton, Mass.) using standard HF wet etch processes. Fluid ports were drilled in-house using a Cameron Micro Drill Press (Sonora, Calif.) with a 2.1 mm diameter Triple Ripple drill bit rotating at 30,000 RPM. For the low-power experiments the fluid ports were 1 cm apart. The chip was thermally bonded to a blank glass chip in a programmable oven (Vulcan 3-550, Neytech, York, Pa.) using the temperature program: 30 min at 440° C., 30 min at 473° C., 6 hours at 592° C. and finally 30 minutes at 473° C. To prepare the channels for PAG photo-polymerization, the channels were washed with a 0.1 M NaOH for 10 minutes and then flushed with DI water and purged with vacuum. To create covalent linkages between the PAG and the channel walls during free-radical polymerization, an oxide self-assembling monolayer was used to functionalize the channel walls with a propyl methacrylate group. A 2:3:5 (v/v/v) mixture of 3-(trimethoxysilyl)-propyl methacrylate, glacial acetic acid and DI water was mixed with an analog vortex mixer and then degassed in a sonicator bath under vacuum for 5 minutes. The solution was introduced into the channels using capillary action and allowed to incubate for 30 minutes. After the incubation, channels were rinsed with methanol and DI water, and then vacuum-purged.

After channel surface preparation, fabrication of the discontinuous pore-size PAG was performed. Gel precursors included 3% to 14% (w/v) acrylamide concentration with a bis-acrylamide crosslinker ratio of 3% (w/w), and 0.2% (w/v) VA-086 dissolved in Tris-glycine buffer (pH 8.3). After degassing, 3 μl of gel precursor was added to a well and allowed to fill the channel through capillary action. Once filled, an additional 3 μl of gel precursor was added to the opposite well. Photo-polymerization was carried out above a Blak-Ray® UV lamp for 10 minutes. Lamp intensity was measured at 10 mW/cm² with a UV light meter (Lutron Electronic Enterprise Co, UV-340A, Taipei, Taiwan). At 1 minute into the exposure and without removing the chip, 10 μl of Tris-glycine buffer was pumped in and out of the sample well four times. The addition of the buffer prevented polymerization in the well, creating a free solution-PAG stacking interface within the microchannel. After polymerization, the device was stored submerged in Tris-glycine buffer at 4° C. until use.

To perform an electrophoretic separation, the sample wash reservoirs were loaded with Tris-glycine buffer and a platinum electrode was inserted into both wells. A 2 μl sample was added into the sample loading reservoir and an electric field was immediately applied. In the low-power experiments, electrophoretic protein migration was controlled by a standard off-the-shelf 9 V battery (Energizer®, St. Louis, Mo.). Current monitoring was performed by placing a 50 kΩ resistor in series with the microchannel and monitoring the voltage drop with a digital multimeter (Agilent 34401A, Santa Clara, Calif.). In all other experiments, continuous control and monitoring of voltage and current levels at each electrode was performed using a high-voltage power supply with current/voltage feedback control. All experiments on the 1 cm channel devices used applied electric fields of 300 V/cm unless otherwise noted.

Fluorescence Imaging

Inverted epi-flourescence imaging of AlexaFluor 488 labeled protein fronts was performed with a Peltier cooled charge-coupled device (CCD) camera (CoolSNAP HQ2, Roper Scientific, Trenton, N.J.) and a 10× objective (UPlanFL, N.A.=0.3, Olympus, Center Valley, Pa.) on an Olympus IX-70 microscope. Camera exposure times ranged from 50 ms to 150 ms with 4×4 pixel binning resulting in an acquisition resolution of 3.3 μm per data point. Light from a 100 W mercury arc lamp was filtered through a XF100-3 filter (Omega Optical, Battleboro, Vt.) for illumination.

Image Analysis

To facilitate comparison between different exposure times as well as to quantify the stacking enrichment factors, the imaging setup was calibrated prior to each experiment. The difference in fluorescence before and after loading labeled sample into the PAG filled channels was divided by the difference in fluorescence before and after the sample was added by capillary action into an empty microchannel. Image analysis was performed with ImageJ software (NIH, Bethesda, Md.). Post processing was performed using MATLAB®. The cross section of the channel for each position along the separation axis (i.e., x-axis) is averaged to yield a single value. A five pixel or frame moving average filter was used in plot profiles or electropherograms, respectively. Front position and variance in either location or migration time was determined by taking the derivative of the plot profile or electropherogram, respectively, and applying a Gaussian peak least-square fitting algorithm. The curve fitting program determined the Gaussian curve conditions (mean and standard deviation) in the last frame of a video sequence (when species are well resolved) and then the videos were regressively analyzed frame by frame passing along curve fitting results from one frame to the initial conditions of the next to automate the process and improve each fit.

### Results and Discussion

Design of PAG MBE The microfluidic devices performed protein electrophoresis over short (1 mm or less) separation lengths in a single microchannel having a single inlet and a single outlet. The microfluidic devices used a single microchannel and did not include T-junctions, double T-junctions, or a cross junction geometry. To minimize sample and buffer loading steps, a homogeneous (not discontinuous) buffer system was used. The sample and buffer traverse through the microfluidic device using electrokinetic control (i.e., no pressure-driven flow).

In certain embodiments, the microfluidic devices facilitate a minimization in injection dispersion. For macro-scale separations, where low applied electric fields (<30 V/cm) separate proteins in centimeters of migration distance, band broadening may be dominated by molecular diffusion (σᵢₙⱼ²/σ₂→0). Here, σ represents the total spatial standard deviations—proportional to the widths (4σ)—of each Gaussian distribution and σᵢₙⱼ² is the injection dispersion. Injection dispersion is largely determined by the sample injection strategy and, thus, the initial zone width (4σᵢₙⱼ) prior to the separation. As separation distances are reduced, the injection dispersion becomes a dominate source of dispersion (σᵢₙⱼ²/σ₂→1).

To assess injection quality and subsequent separation resolution (RS) for resolving species in MBE, the spatial derivative of the concentration profile

$$( \frac{d C ( x )}{d x} )$$

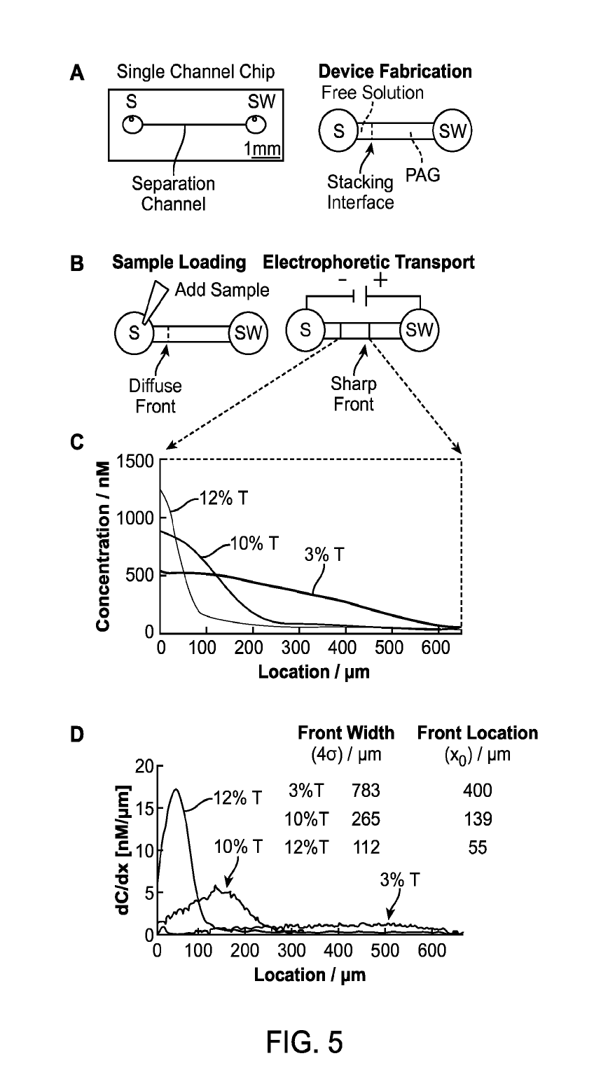

was determined. The concentration front description may be transformed into a Gaussian distribution:

$$\frac{d C ( x )}{d x} = \frac{A}{\sqrt{2 π} σ} exp ( - \frac{{( x - {x}_{0} )}^{2}}{2 {σ}^{2}} ) \qquad ( 1 )$$

where A is a constant, χ is the axial position along the channel, and χ₀ is the mean axial location of the resultant Gaussian distribution. Minimization of MBE injection dispersion was performed using a polyacrylamide (PA) stacking gel at the upstream end of the MBE separation channel (FIGS. 5A and 5B) to both reduce injection dispersion and impart molecular sieving for electrophoretic mobility based protein separations.

In PAGE, analyte mobility (μ), which is directly proportional to migration rate (U), can be related to PAG pore-size via the Ferguson relationship, where μ=μ₀10^{-KT}. Where μ₀ is the free solution mobility, K is the retardation coefficient and T is the total acrylamide concentration in the precursor solution (gel density). As the gel density is increased, PAG pore-size is reduced. The retardation coefficient is related to protein size and shape, resulting in protein mobility decreasing exponentially with an increase in molecular mass or gel density. Thus, a physically induced shift in migration rate as an analyte moves from free solution (U₀) into the sieving matrix (U) resulted in MBE front sharpening. Assuming a short separation length and fast separation time (t), where σᵢₙⱼ²/σ₂→1, RS for PAG MBE can be described by:

$$RS ≅ \frac{Δ Ut}{4 {σ}_{inj}} \cdot \frac{{U}_{0}}{U} \qquad ( 2 )$$

Thus, the PA gel would both enrich the sample and increase the concentration front by a factor of U₀/U, thereby enhancing RS by the same ratio. Increased gel density would result in lower protein in-gel mobility, thus the width of the analyte front would be further reduced until the limiting case, where species are excluded from the PAG region. In certain instances, the PAG size selective sieving matrix may act to enhance the differential mobility between proteins (ΔU).

Minimizing MBE Injection Dispersion via a PAG Stacking Interface

To characterize the impact of the injected concentration front on PAG MBE separation performance in a short microchannel, the injection dispersion of analyte fronts electromigrating through various free solution-PAG stacking interfaces was studied (FIGS. 5C and 5D). The entry region condition of free solution was selected to maximize the migration shift (U₀/U) to improve separation performance, as described in Eqn. (2) above. Additionally, the presence of the PAG region downstream of the free solution region minimized bulk flows in the injector region thus facilitating a reduction in Poiseuille flow induced dispersion. The free solution-PAG stacking interface was located 600 μm into the MBE separation channel, thus nominally at the head of the separation channel of total length 10 mm. FIG. 5C shows a graph of PAG MBE stacking of a single model analyte front (TI*, 500 nM) as the analyte electromigrated through each of three different stacking conditions (free solution to PAG regions of 3% T, 10% T and 12% T).

The concentration fronts in FIG. 5C show that a transition from free solution to the smaller pore-size PAG regions (10% T, 12% T) increased the amplitude of the front and reduced axial penetration of the concentration front into the microchannel, as compared to larger pore-size PAG regions (3% T) at the same time point. To determine the location and width of each MBE front, standard deviations for each Gaussian distribution were computed from the spatial derivative of the MBE concentration profiles (Eqn. 1) (FIG. 5D). The resulting standard deviation for each analyte front (i.e., in each of the three PA stacking gel configurations) gave values of: σ=196 μm±34 μm for injection into a 3% T PAG, σ=66 μm±1 μm for 10% T PAG, and σ=28 μm±1 μm for 12% T PAG (n=3 for each). By using the 3% T as free-solution approximation (σ₀≈σ_{3% T}), a reduction in front width (σ₀/σ_{% T}) of 3.0±0.5 was observed for the 10% T PAG configuration and 7.0±1.3 for the 12% T PAG configuration. Thus, with a small pore-size, the PAG stacking interface reduced the equivalent injection peak width by over 85% for the three cases considered here. Even with the homogeneous buffer system used in the experiments, PAG stacking concentrated and sharpened the protein fronts while the presence of the sieving matrix facilitated a reduction in undesirable bulk flow effects and reduced the rate of molecular diffusion.

The stacking gel configuration for PAG MBE was studied for use as a separation medium. As shown in FIGS. 5C and 5D, the mobility of the front slowed with an increase in PAG density. For example, at an elapsed separation time of 4 s, the concentration front locations were measured at: X₀=400 μm±6 μm for a 3% T PAG, X₀=139 μm±5 μm for a 10% T PAG, and X₀=55 μm±8 μm for a 12% T PAG (n=3 for each). Using the 3% T PAG measurements as a free-solution approximation of the TI* mobility, TI* migration shifts (U₀/U_{% T}) were evaluated in PAG of higher densities, yielding: 2.9±0.1 for X_{0, 3% T}/X_{0, 10% T} and 7.3±1.1 for X_{0, 3% T}/X_{0, 12% T}. Based on Eqn. (2), the reduction of front width from the free-solution case should be directly related to the measured migration shift. The close match between migration shift (U₀/U_{% T}) and MBE front sharpening (σ₀/σ_{% T}) for both the 10% T and 12% T PAGs investigated here indicated that PAG MBE front sharpening can be accurately described by the PAG sieve induced migration shift.

PAG MBE Separation Conditions for Native Protein Analysis

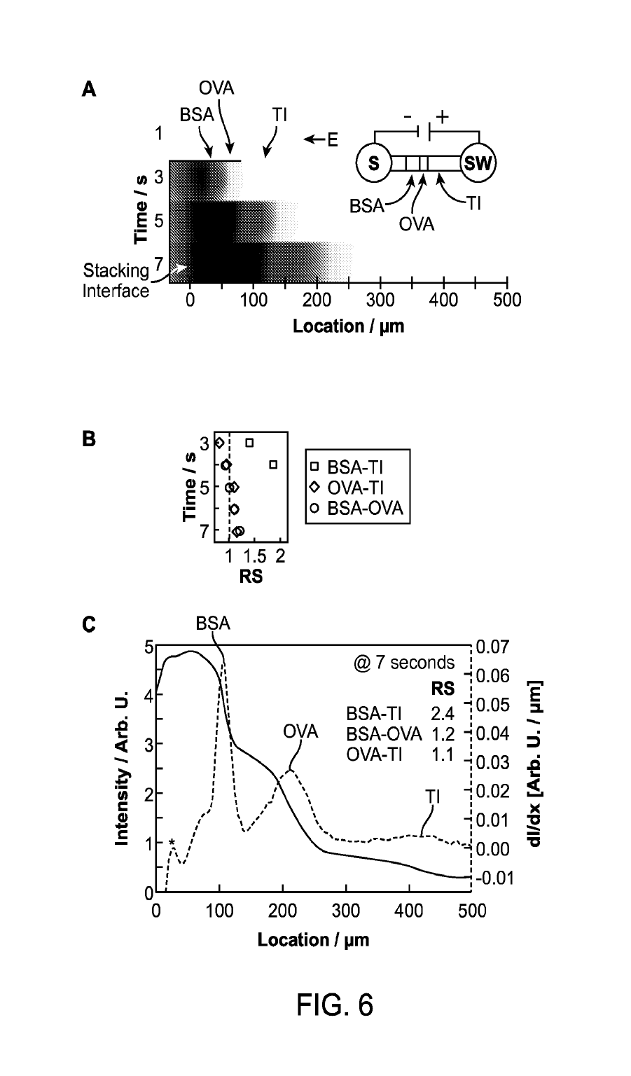

For PAG MBE for native proteins over short separation lengths, the influence of MBE separation conditions on RS was characterized. FIG. 6 shows full field imaging results from a PAG MBE separation of a ladder of three native proteins. A free solution −12% T PA stacking gel interface located 600 μm from the sample well was used. The time evolution video microscopy of the PAG MBE protein ladder separation is shown in FIG. 6A, at 2× real time. E=300 V/cm, 12% T PAG.

The false color micrographs in FIG. 6A show the electromigration of concentration fronts into the PAG MBE separation channel. Within a 3 s elapsed separation duration, all three fronts transitioned through the free solution PA stacking gel and were visually detectable. Identification of each ladder species was verified a priori through MBE analysis of each species alone thus yielding an apparent electrophoretic mobility for each.

For the three ladder pairs studied (BSA*-OVA*, OVA*-TI*, BSA*-TI*), RS was monitored in time to determine the elapsed separation time and total separation length needed to baseline resolve the native species. FIG. 6B shows that within 5 s all protein pairs were resolved, with a RS of 1.0, 1.1 and 2.3 for the BSA*-OVA*, OVA*-TI* and BSA*-TI* pairs, respectively. FIG. 6C shows the PAG MBE separation at 7 s of elapsed separation time. Each of the three species present was enriched upon passing through the 12% T PAG interface, with BSA* being enriched by a factor of 5.1 factor, and TI* being enriched by the 12% T interface by a factor of 2.5, with this sized-based bias in enrichment due to the size-based migration shift mechanism operating at the PAG stacking interface. The TI* front (peak) was more disperse than those of either of the larger protein species assayed. The observed differences in enrichment and dispersion between BSA* and TI* may be due to the differences of their retardation coefficients (K_{BSA}>K_{TI}). The resolved PAG MBE separation of the model protein ladder was performed in 500 μm of migration in the PAG sieving matrix with the full field imaging readout used here for PAG MBE characterization. The native assay results presented in FIG. 6 show that PAG MBE is capable of performing protein separations in a single straight 2 port channel.

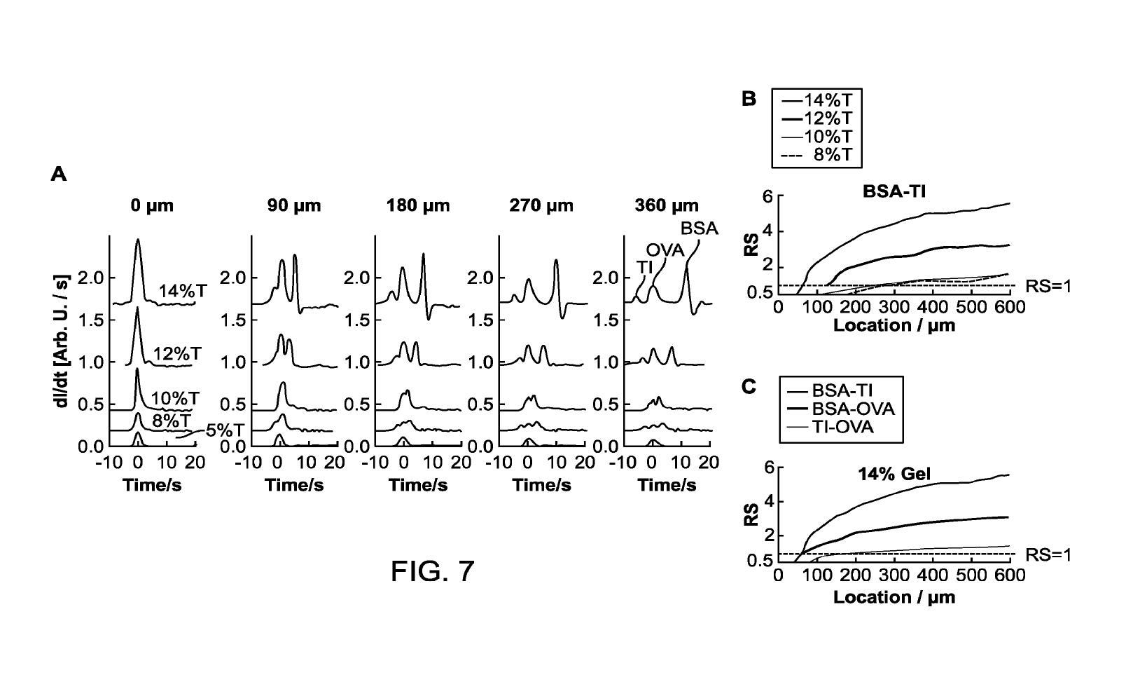

Electropherograms were determined at sequential locations along the channel for PAG MBE separations in five PAG densities (5% T, 8% T, 10% T, 12% T, and 14% T) in order to determine the minimum separation channel length for a native protein analysis. FIG. 7A shows a graph of the electropherogram derivative at 90 μm intervals along the PAG sieving matrix. Evolution of the separation in time was monitored by computing RS as a function of migration distance for each PAG density (FIG. 7B). No separation was observed in the 5% T gel. Over the same distance the BSA*-TI* separations were resolved (RS=1) at 283 μm, 242 μm, 128 μm and 61 μm for the 8% T, 10% T, 12% T, and 14% T PAGs, respectively. For each experiment the RS increased with the square root of the migration distance. The improved resolution in dense gels was also apparent in projected peak capacity for a 1 mm channel. When TI was used as the reference analyte, which has the highest mobility and diffusivity of the protein ladder, the peak capacity was 3.5 in a 10% T gel, 5.2 in a 12% T gel, and 6.5 in a 14% T gel.

Peak capacity for a 1 mm separation length for the separations shown in FIG. 7 were calculated for each gel density by taking the protein elution time for 1 mm of PAG migration divided by the temporal bandwidth of the protein after all species in the ladder had been resolved. This was performed for both TI and BSA, the smallest and largest proteins of the ladder, respectively.

When BSA was used, the peak capacity was 4.0 in a 10% T gel, 8.9 in a 12% T gel, and 10.1 in a 14% T gel. The results indicated that this was sufficient for migration shift assays. In the 14% T PAG configuration, all separations were completed in the first 200 μm of the separation medium, with a RS of 1.0, 2.2 and 3.7 observed for the OVA*-TI*, BSA*-OVA* and BSA*-TI* separations, respectively, as shown in FIG. 7C.

In the 14% T separation a “system peak” (negative signal) was observed behind the BSA peak at 360 μm in FIG. 7A. The system peak may be attributed to the decreased signal to physical exclusion of a BSA dimer at the stacking gel interface. The system peak can be further enhanced by gel non-uniformities near the solution—PAG interface. Characterized previously for photo-patterned discontinuities, the interface gel can exhibit significantly smaller pore-size than bulk PAG. This reduced pore-size at a free solution—PAG interface may prevent large analytes, which normally would be able to migrate in a given PAG density, from entering the separation medium. This may be addressed through the use of slightly lower gel densities than employed in bulk uniform gels. Secondly, the non-uniformity can complicate spatial detection of fronts close to the interface (<100 μm), as indicated in FIG. 6C. To address this, temporal detection may be used when performing protein PAG MBE analysis within short separation lengths.

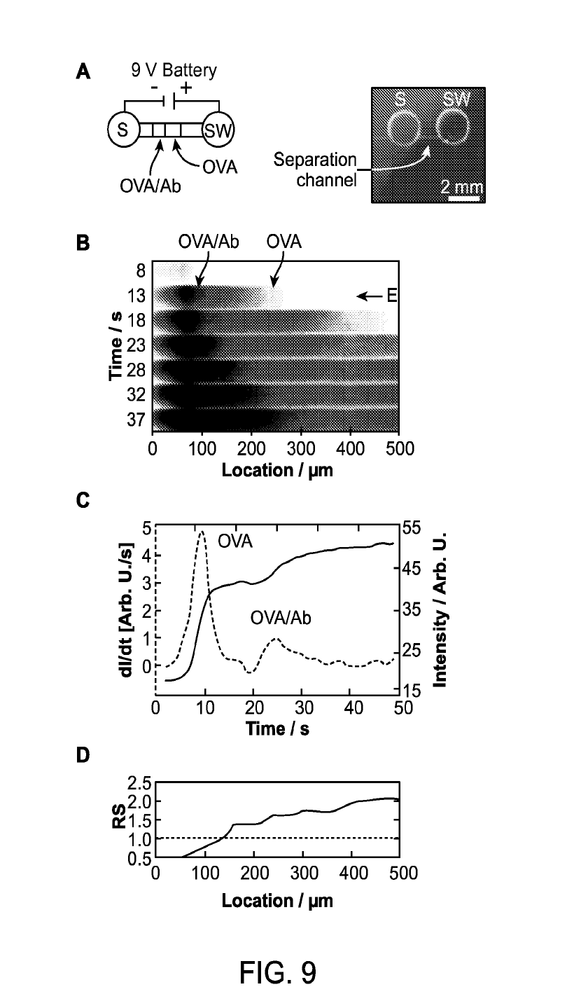

Homogeneous Electrophoretic Immunoassay for Low-Power Microfluidic Devices Experiments were performed using a single channel 2-port microfluidic device for an electrophoretic immunoassay (EIA) powered by an off-the-shelf 9 V battery with no voltage amplification (FIG. 9). In certain embodiments, low-power microfluidic devices may be portable and battery powered, and may find use in applications such as remote environmental sensing and point-of-care medical diagnostics.

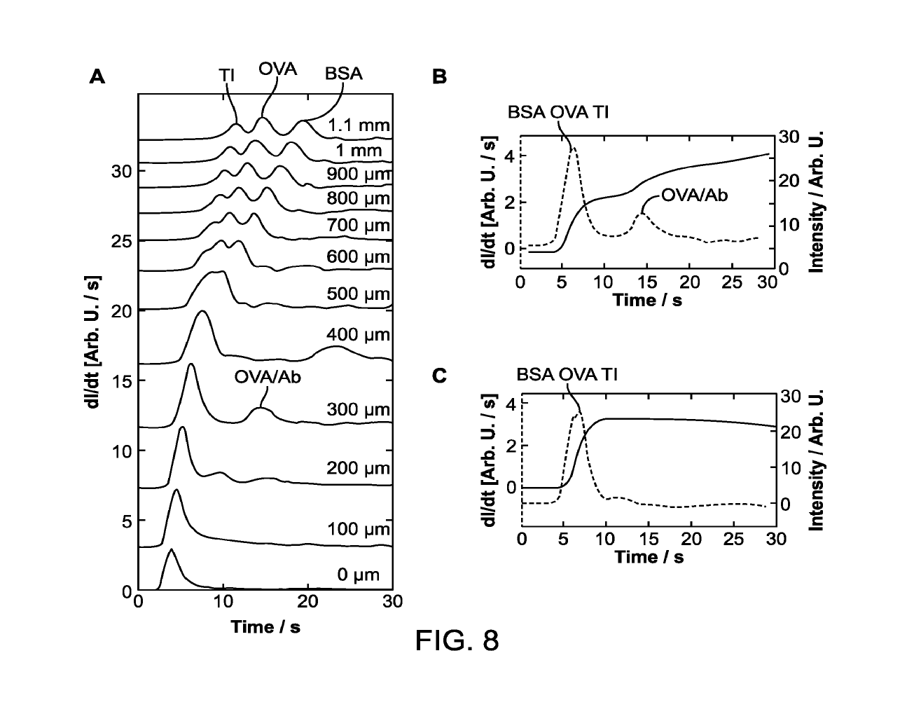

First, experiments were performed testing the separation performance of PAG MBE in homogeneous EIAs in a 1 cm long separation channel (as described in FIG. 5A), using a conventional high-voltage control. For direct comparison to the native protein PAG MBE assays detailed above, a PAG MBE separation was performed on the three protein ladder as described above. Then an EIA for OVA was added by including an unlabeled polyclonal OVA antibody (75 nM) in the three protein native ladder. The combined OVA EIA and protein separation were conducted in a 10% T PAG device, which was a density of gel that minimized noticeable size-based immobilization of immune-complexes in the gel structure. As shown in FIG. 8A, the OVA immunoassay was completed at 300 μm beyond the stacking gel (FIG. 8B). The migrating front of the protein ladder sample passed at 5 s followed by the slow migrating OVA*/anti-OVA immune-complex front at 15 seconds. At lengths farther downstream, the protein ladder separations were completed as detailed in the previous section. The EIA was verified with a negative control in FIG. 8C, with the same protein ladder and an antibody non-specific to any protein in the ladder.

Next, an EIA experiment was performed using a short channel, low-power electrophoresis microfluidic device. A 10× shorter (1.3 mm long) glass microchannel housing the PAG gel configuration shown in FIG. 5A (6% T PAG) was fabricated. Here, though, the OVA EIA was powered by a 9 V off-the-shelf battery (FIG. 9A). The time-evolution of the homogeneous EIA is shown in FIG. 9B. The PAG MBE resolved the migrating OVA* and immune-complex peaks in 25 s with a separation length of 140 μm beyond the stacking gel (FIGS. 9C and 9D). 11% of the total fabricated separation medium length was utilized for the PAG MBE immunoassay. The channel length was 1.3 mm.

In the low-power assay, the 9 V battery drove a 300 nA current resulting in a 3 μW immunoassay. The 3 μW assay demonstrated here could theoretically be powered by an off-the-shelf 9 V battery for over 200 years (ignoring natural degradation).

Although the foregoing embodiments have been described in some detail by way of illustration and example for purposes of clarity of understanding, it is readily apparent to those of ordinary skill in the art in light of the teachings of the present disclosure that certain changes and modifications may be made thereto without departing from the spirit or scope of the appended claims. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A microfluidic system comprising:
a microfluidic device comprising a single electrophoretic channel containing a separation medium; and
a processor configured to detect differentially migrating analytes in the separation medium by a moving boundary electrophoresis (MBE) protocol.

2. The system according to claim 1, wherein the separation medium comprises a polymeric gel.

3. The system according to claim 1, wherein a first portion of the channel is substantially free of the separation medium and a second portion of the channel contains the separation medium.

4. The system according to claim 3, wherein the first portion of the channel is upstream from the second portion of the channel.

5. The system according to claim 1, wherein the channel has a length of 1.5 mm or less.

6. The system according to claim 1, wherein the microfluidic device further comprises a fluid input port in fluid communication with an upstream end of the channel.

7. The system according to claim 1, wherein the microfluidic device further comprises a fluid output port in fluid communication with a downstream end of the channel.

8. The system according to claim 1, wherein the system further comprises a power source configured to apply an electric field to the channel.

9. The system according to claim 8, wherein the power source comprises a battery.

10. The system according to claim 1, wherein the system further comprises a detector.

11. The system according to claim 1, wherein the system comprises an array of two or more microfluidic devices.

12. A method of assaying a fluid sample for the presence of an analyte, the method comprising:
introducing the fluid sample into a microfluidic device comprising a single electrophoretic channel containing a separation medium; and
detecting differentially migrating analytes in the channel by a moving boundary electrophoresis (MBE) protocol to assay the fluid sample for the presence of the analyte.

13. The method according to claim 12, further comprising applying an electric field to the channel.

14. The method according to claim 12, wherein the introducing comprises continuously introducing the fluid sample into the microfluidic device during the assay.

15. The method according to claim 12, wherein the separation medium comprises a polymeric gel.

16. The method according to claim 12, wherein a first portion of the channel is substantially free of the separation medium and a second portion of the channel contains the separation medium.

17. The method according to claim 16, wherein the first portion of the channel is upstream from the second portion of the channel.

18. A kit comprising:
a microfluidic device comprising a single electrophoretic channel containing a separation medium and configured to separate differentially migrating analytes in the separation medium by a moving boundary electrophoresis (MBE) protocol; and
a buffer.

19. The kit according to claim 18, further comprising a power source configured to apply an electric field to the channel.

20. The kit according to claim 19, wherein the power source comprises a battery.
